(19) United States
(12) Patent Application Publication
(10) Pub. No.: US 2026/0037568 A1
(43) Pub. Date: Feb. 5, 2026

(54) SYSTEMS, METHODS, AND COMPUTER-READABLE MEDIA FOR OPERATING A PERSONA-DRIVEN INTELLIGENCE PLATFORM

(71) Applicant: AccessFuel, Inc., Santa Monica, CA (US)

(72) Inventors: Robert IMRIE, Marina del Rey, CA (US); Adel TAHRI, Biskra (DZ)

(21) Appl. No.: 19/290,961

(22) Filed: Aug. 5, 2025

Related U.S. Application Data
(60) Provisional application No. 63/679,461, filed on Aug. 5, 2024.
(60) Provisional application No. 63/736,913, filed on Dec. 20, 2024.

(51) Int. Cl. G06F 16/353; G06F 16/335

(52) U.S. Cl. CPC G06F 16/353; G06F 16/337

(57) ABSTRACT

Methods and systems are provided for operating a persona-driven intelligence platform. Responsive to receiving inputs and/or instructions corresponding to a digital task, data records are retrieved from a database. The data records are clustered to generate a plurality of clusters of data records, based on a first set of attributes. A corresponding second set of attributes is obtained for each of the plurality of clusters, and a corresponding personality score vector is generated for each of the plurality of clusters, based on the second set of attributes. A dynamic persona corresponding to at least one of the plurality of clusters is generated by one or more large language model (LLM) agents and stored in a persona library. The disclosed methods and systems may enable improved real-time management of audience-driven digital workflows by automating unique persona generation, for enabling the optimization of digital tasks and data workflows to maximize relevancy.

### CROSS-REFERENCE TO RELATED APPLICATION

This application claims the benefits of priority to U.S. Provisional Patent Application No. 63/679,461, filed Aug. 5, 2024, titled SYSTEMS, METHODS, AND COMPUTER-READABLE MEDIA FOR OPERATING A PERSONA-DRIVEN INTELLIGENCE PLATFORM, and U.S. Provisional Patent Application No. 63/736,913, filed Dec. 20, 2024, titled SYSTEMS, METHODS, AND COMPUTER-READABLE MEDIA FOR OPERATING A PERSONA-DRIVEN INTELLIGENCE PLATFORM the contents of which are hereby expressly incorporated into the present application by reference in their entirety.

### FIELD

The present disclosure relates to machine learning (ML) for data management, and more particularly, to using ML to perform digital tasks and enhance digital workflows in data management systems, and yet more particularly, to systems and methods for data management using dynamic personas within a persona-driven intelligence platform.

### BACKGROUND

Organizations often have user and operational data spread across multiple platforms and systems (e.g., applications), leading to a fragmented (or siloed) view of their data. This disconnect hampers the ability to gain comprehensive insights from available data (e.g., user and business data) and make informed and optimized “data driven” decisions, particularly based on the continually changing needs and interests of users and the ever-changing data within these applications.

Accordingly, it would be useful to provide improved techniques for consolidating and leveraging business and customer data to improve operational workflows.

### SUMMARY

Methods and systems are provided for operating a persona-driven intelligence platform. Responsive to receiving inputs and/or instructions corresponding to a digital task, data records are retrieved from a database. The data records are clustered to generate a plurality of clusters of data records, based on a first set of attributes. A corresponding second set of attributes is obtained for each of the plurality of clusters, and a corresponding personality score vector is generated for each of the plurality of clusters, based on the second set of attributes. A dynamic persona corresponding to at least one of the plurality of clusters is generated by one or more large language model (LLM) agents and stored in a persona library. The disclosed methods and systems may enable improved real-time management of audience-driven digital workflows by automating unique persona generation, for enabling the optimization of digital tasks and data workflows to maximize relevancy.

In a first aspect of the present disclosure, there is provided a computer-implemented method for operating a persona-driven intelligence platform comprising: responsive to receiving one or more inputs and/or instructions corresponding to a digital task, retrieving, from a database in memory of a computing system, a plurality of data records, each data record including a first set of attributes; clustering the plurality of data records to generate a plurality of clusters of data records, based on the first set of attributes; obtaining, for each of the plurality of clusters, a corresponding second set of attributes; generating, for each of the plurality of clusters, a corresponding personality score vector, based on the second set of attributes; generating, by one or more LLM agents, a dynamic persona corresponding to at least one of the plurality of clusters, the dynamic persona including a third set of attributes; and storing the dynamic persona in a persona library.

In an example of the first aspect of the present disclosure, further comprising: responsive to receiving the one or more inputs, generating a targeted digital communication corresponding to the digital task, wherein generating the targeted digital communication comprises: generating, by the one or more LLM agents a personalized content for the targeted digital communication, based on the third set of attributes; and delivering the targeted digital communication including the personalized content to a group of users associated with the at least one of the plurality of clusters via an electronic distribution channel.

In an example of the first aspect of the present disclosure, wherein the plurality of data records is retrieved from the database based on a persona relevance score (PRS), the PRS corresponding to a likelihood of a positive user engagement with respect to the digital task.

In an example of the first aspect of the present disclosure, wherein the PRS is calculated based on engagement metrics corresponding to historical user interactions captured in the plurality of data records, the engagement metrics including at least: a place order rate; a total number of recipients; an open rate; a click rate; and a non-engagement data.

In an example of the first aspect of the present disclosure, wherein the plurality of data records that are retrieved from the database correspond to one or more core personas stored in the persona library.

In an example of the first aspect of the present disclosure, wherein obtaining the second set of attributes comprises: for each of the plurality of clusters: aggregating the corresponding data records to generate the second set of attributes.

In an example of the first aspect of the present disclosure, wherein the personality score vector for each of the plurality of clusters is generated by a fine- tuned LLM.

In an example of the first aspect of the present disclosure, wherein the personality score vector for each of the plurality of clusters is generated by a trained classification model.

In an example of the first aspect of the present disclosure, wherein the personality score vector is a numerical representation of one or more personality traits corresponding to an OCEAN personality model or a 16 personalities model.

In an example of the first aspect of the present disclosure, wherein the third set of attributes includes at least one of: a brand story; demographics; psychographics; engagement guidelines; behavior guidelines; tone and style of textual content; communication recommendations; a persona name; a persona image; a persona video; persona features; a persona audio; or a persona storyline.

In an example of the first aspect of the present disclosure, wherein the one or more LLM agents are multi-agents.

In a second aspect of the present disclosure, there is provided a system comprising: one or more processor devices; and one or more memories storing machine-executable instructions, which when executed by the one or more processor devices, cause the system to: responsive to receiving one or more inputs and/or instructions corresponding to a digital task, retrieve, from a database in memory of a computing system, a plurality of data records, each data record including a first set of attributes; cluster the plurality of data records to generate a plurality of clusters of data records, based on the first set of attributes; obtain, for each of the plurality of clusters, a corresponding second set of attributes; generate, for each of the plurality of clusters, a corresponding personality score vector, based on the second set of attributes; generate, by one or more LLM agents, a dynamic persona corresponding to at least one of the plurality of clusters, the dynamic persona including a third set of attributes; and store the dynamic persona in a persona library.

In an example of the second aspect of the present disclosure, wherein the machine-executable instructions, when executed by the one or more processor devices, further cause the system to: responsive to receiving the one or more inputs, generate a targeted digital communication corresponding to the digital task by: generating, by the one or more LLM agents a personalized content for the targeted digital communication, based on the third set of attributes; and delivering the targeted digital communication including the personalized content to a group of users associated with the at least one of the plurality of clusters via an electronic distribution channel.

In an example of the second aspect of the present disclosure, wherein the plurality of data records is retrieved from the database based on a persona relevance score (PRS), the PRS corresponding to a likelihood of a positive user engagement with respect to the digital task.

In an example of the second aspect of the present disclosure, wherein the PRS is calculated based on engagement metrics corresponding to historical user interactions captured in the plurality of data records, the engagement metrics including at least: a place order rate; a total number of recipients; an open rate; a click rate; and a non-engagement data.

In an example of the second aspect of the present disclosure, wherein the plurality of data records that are retrieved from the database correspond to one or more core personas stored in the persona library.

In an example of the second aspect of the present disclosure, wherein in obtaining the second set of attributes, the machine-executable instructions, when executed by the one or more processor devices, cause the system to: for each of the plurality of clusters: aggregate the corresponding data records to generate the second set of attributes.

In an example of the second aspect of the present disclosure, wherein the personality score vector for each of the plurality of clusters is generated by a fine-tuned LLM.

In an example of the second aspect of the present disclosure, wherein the personality score vector for each of the plurality of clusters is generated by a trained classification model.

In an example of the second aspect of the present disclosure, wherein the personality score vector is a numerical representation of one or more personality traits corresponding to an OCEAN personality model or a 16 personalities model.

In an example of the second aspect of the present disclosure, wherein the third set of attributes includes at least one of: a brand story; demographics; psychographics; engagement guidelines; behavior guidelines; tone and style of textual content; communication recommendations; a persona name; a persona image; a persona video; persona features; a persona audio; or a persona storyline.

In an example of the second aspect of the present disclosure, wherein the one or more LLM agents are multi-agents.

In a third aspect of the present disclosure, there is provided a non-transitory computer-readable medium storing machine-executable instructions which, when executed by one or more processors of a computing system, cause the one or more processors to: responsive to receiving one or more inputs and/or instructions corresponding to a digital task, retrieve, from a database in memory of a computing system, a plurality of data records, each data record including a first set of attributes; cluster the plurality of data records to generate a plurality of clusters of data records, based on the first set of attributes; obtain, for each of the plurality of clusters, a corresponding second set of attributes; generate, for each of the plurality of clusters, a corresponding personality score vector, based on the second set of attributes; generate, by one or more LLM agents, a dynamic persona corresponding to at least one of the plurality of clusters, the dynamic persona including a third set of attributes; and store the dynamic persona in a persona library.

In a fourth aspect of the present disclosure, there is provided a computer-implemented method for operating a persona-driven intelligence platform comprising: receiving, from a user device, one or more inputs corresponding to an objective; querying a data warehouse to retrieve data associated with the objective; generating, by one or more LLM agents, a response corresponding to the objective, based on the retrieved data; and transmitting a signal to cause a display of the user device to provide output based on the response.

In an example of the fourth aspect of the present disclosure, wherein querying a data warehouse comprises: obtaining one or more encoded representations of the objective; retrieving one or more candidate queries from a vector database, based on a similarity to the one or more encoded representations; providing the one or more candidate queries to the one or more LLM agents, for generating a query to the data warehouse for retrieving data associated with the objective.

In a fifth aspect of the present disclosure, there is provided a system comprising: one or more processor devices; and one or more memories storing machine-executable instructions, which when executed by the one or more processor devices, cause the system to: receive, from a user device, one or more inputs corresponding to an objective; query a data warehouse to retrieve data associated with the objective; generate, by one or more LLM agents, a response corresponding to the objective, based on the retrieved data; and transmit a signal to cause a display of the user device to provide output based on the response.

In an example of the fifth aspect of the present disclosure, wherein the machine-executable instructions, when executed by the one or more processors to query the data warehouse, cause the system to: obtain one or more encoded representations of the objective; retrieve one or more candidate queries from a vector database, based on a similarity to the one or more encoded representations; provide the one or more candidate queries to the one or more LLM agents, for generating a query to the data warehouse for retrieving data associated with the objective.

### BRIEF DESCRIPTION OF THE DRAWINGS

Reference will now be made, by way of example, to the accompanying drawings which show example embodiments of the present application, and in which:

FIG. 1 a schematic diagram illustrating an exemplary simplified system in which exemplary embodiments described in the present disclosure may be implemented;

FIG. 2 is a schematic diagram illustrating an exemplary hardware structure of a computing system that is suitable for implementing exemplary embodiments of the present disclosure;

FIG. 3 is a schematic diagram of various components of a persona-driven intelligence platform executed by a computing system, such as a server of FIG. 1, in accordance with exemplary embodiments of the present disclosure;

FIG. 4 is a schematic diagram of various components of a persona management platform in accordance with exemplary embodiments of the present disclosure;

FIG. 5A is a schematic diagram of various components of a persona engine in accordance with exemplary embodiments of the present disclosure;

FIG. 5B is a schematic diagram of an exemplary persona generated in accordance with exemplary embodiments of the present disclosure;

FIG. 5C is a schematic diagram of various categories of personas, in accordance with examples of the present disclosure;

FIG. 5D is a simplified persona generator user interface (UI), which may be implemented by an example of the UI module in accordance with exemplary embodiments of the present disclosure;

FIG. 6 is a schematic diagram of various components of a personalization engine in accordance with exemplary embodiments of the present disclosure;

FIG. 7 is a flowchart illustrating a method for operation of a persona management platform, in accordance with example embodiments of the present disclosure;

FIG. 8 illustrates an exemplary simplified artificial intelligence (AI) chat agent UI, which may be implemented by an example of the persona-driven intelligence platform as disclosed herein;

FIG. 9 is an exemplary simplified AI chat agent UI, which may be implemented by an example of the persona-driven intelligence platform as disclosed herein.

FIG. 10 illustrates an exemplary simplified AI chat agent UI, which may be implemented by an example of the persona-driven intelligence platform as disclosed herein; and

FIG. 11 shows a schematic diagram of various components of a query engine, in accordance with examples of the present disclosure.

FIG. 12 is a flowchart illustrating a method for operation of a persona management platform, in accordance with example embodiments of the present disclosure;

Similar reference numerals may have been used in different figures to denote similar components.

### DETAILED DESCRIPTION

Existing systems for managing data and extracting business intelligence from data (e.g., using digital workflows) are often distributed across multiple platforms and systems, introducing complexity and inefficiency in data analysis, and hampering the ability for an organization to make data-driven operational decisions. Personas are high-fidelity, accurate representations of an audience (e.g., existing users and prospective users, among other individuals of a wider population) that may be incorporated into business operations for improved decision making, planning (e.g., forecasting) and implementation of digital workflows. Businesses and tools (e.g., platforms, applications etc.) often attempt to incorporate user segments (e.g., by filtering users as a basic form of personas) into operations of various business units to better understand the needs and behaviors of a specific audience, however the process of generating accurate and effective personas (e.g., often manual or performed using generalized tools that provide basic filtering capabilities), is a time-consuming process, often resulting in inadequate depth and accuracy. Such tools also lack effective visualization of the data (e.g., persona image or video), making it challenging for organizations to relate to their audiences. Furthermore, personas may quickly become outdated as new data is received.

A large language model (LLM) is one tool that can be used to generate personas, however, using an LLM as a persona generator consumes extensive computing resources (e.g., processing power, memory, computing time, etc.), particularly for large volumes of data that come from various internal sources (e.g., individual applications) that make up an organization's technology “stack”, such as a database (e.g., CRM or CDP) of users (e.g., an audience), as well as external sources, such as third-party partners, licensors and vendors (e.g., providing or licensing data). LLMs are computationally intensive, requiring extensive memory and processing power for both training and inferencing tasks. Depending on the size and complexity of the dataset, LLMs can be costly to operate in terms of cost per token.

Systems and methods are provided for real-time management of audience-driven digital workflows. Examples of the disclosed persona-driven intelligence platform may improve the performance of data management systems by automating unique persona generation, personalizing audience-facing content (in various formats, such as websites, landing pages, emails, newsletters and text/sms messages, among other possibilities) and on various distribution channels, such as web-based, social media, email, mobile (e.g., text/sms messages and notifications) etc. to match individual preferences and behaviors, and/or to automatically optimize digital tasks and data workflows to maximize relevancy (e.g., via personalization), facilitate engagement, and ultimately improve organization performance.

Examples of the disclosed persona-driven management platform enable the collection, exploration, analysis and use of audience data, for example, including existing, first-party, derived, and third-party data associated with an audience from various data sources (including, for example, a consolidated “Golden” or simply “consolidated” database representing a single, well-defined, and trusted source of information, for example, acting as the “System of Record” (SOR) and/or “Source of Truth” (SOT) for organizations), to automatically generate highly detailed, accurate, and dynamic personas for users and/or target audiences of an organization. In exemplary embodiments, generated personas may be dynamically updated based on interaction, behavior, and/or engagement data, and incorporated into digital workflows to promote audience engagement and/or satisfaction (e.g., by tracking, measuring, learning, updating and creating persona-driven interactions) and inform operational processes. In other examples, generated personas may provide insights for improved audience interaction, for example, by selecting the most relevant medium and distribution channel (e.g., online, on the phone, email etc.) and format (e.g., by personalizing the copy, tone, “character”, offer, price, etc.)

The disclosed systems and methods may further provide multiple business units and key stakeholders within an organization with valuable insights to develop and execute an integrated, personalized and aligned strategy. This provides a technical advantage in reducing the unnecessary consumption of computing resources (e.g., processing power, memory, computing time, etc.) associated with inefficient or inaccurate data management workflows and/or business unit alignment.

In various exemplary embodiments, the solution provides a technical effect of integrating, centralizing and/or consolidating and normalizing data from multiple sources, employing several AI agents (“multi-Agents”) for analyzing and interpreting (e.g., deriving actionable insights, reports etc.) from the data, and based on the interpretation (e.g., providing recommendations), employing advanced AI and machine learning (ML) models for data enrichment (e.g., utilizing third-party sources or internal algorithms for making inferences from or deriving new data based on existing data and organization-generated data that can be used to cross-reference audiences, markets, industries, competition etc.). In this regard, enriched data may inform the generation of personalized content to optimally elicit audience engagement. Advantageously, use of an enriched and consolidated “Master” or “Golden” dataset enables improved interpretation and extracting additional insights from audience data, for example, when AI agents are deployed to answer industry-specific, business-specific and audience-specific questions or generate recommendations. Furthermore, embodiments of the present solution enable organizations to utilize data from embedded advanced analytics tracking tools (e.g., tracking pixels, among other possibilities in digital pages and content) in digital workflows, which enables detailed behavioral tracking of audience interactions. For example, analytics may be fed back into the consolidated or “Golden” database (e.g., which acts as the ‘Source of Truth’), for example, for updating individual data records for use in future digital workflows. For example, measuring and updating corresponding audience records in the consolidated database enables optimizing in near real-time, the next interaction with that audience member. In other examples, analytics may be fed back into the consolidated database for updating forecasted or predicted information, for example, predicted revenue or growth metrics (e.g., driven by updates to KPIs, etc.). In examples, updated forecasts or predictions may be reflected in the consolidated database and visualized data (e.g., charts, reports, or other visualizations, such as in a dashboard, among other possibilities).

In various exemplary embodiments, the solution provides a technical effect of automatically generating personas according to dynamic conditions within an organization (including forward-looking organizational goals and objectives) or responsive to changing audience data. In an exemplary scenario, a marketing business unit with an upcoming promotion may dynamically create targeted personas (e.g., “campaign personas”) and corresponding digital communications (such as copy, creative, color, communication medium, distribution channel, time of day to deploy, price and/or discount, product(s) and bundled products, etc.) that are directed toward a predicted highest-performing audience segment (e.g., “campaign persona”), based on organizational goals and objectives (e.g., product, campaign, or revenue targets, among other KPIs), for example, where the corresponding digital communications may include personalized content and where distribution across digital channels may be optimized for the campaign persona. In this regard, personalized campaign generation and delivery may enable optimized campaign performance (e.g., as evaluated by marketing KPIs such as open rates (OR), click-through rates (CTR) and sales KPIs such as average order value (AOV), lifetime value (LTV) and purchase frequency, among other possibilities), responsive to the selection of appropriate distribution channels and the combination and/or order of selected distribution channels for an omnichannel deployment across multiple channels, the identification of an optimal time for campaign deployment, the creation of ideal products or product bundles, and the provision of actionable insights and recommendations to drive business and/or revenue growth.

In various exemplary embodiments, the solution provides a technical effect that knowledge associated with generative models (e.g., LLMs or fine-tuned LLMs) can be distilled into a smaller, more computationally efficient ML model using a synthetically generated labeled training dataset, which may be validated by human input. The labeled training dataset may be used for training a smaller ML model, such as a classification model, by supervised learning (e.g., using supervised learning techniques and/or algorithms). In examples, the classification model may be a personality classifier for classifying a plurality of personality traits associated with an audience. In examples, the personality classifier may be incorporated into digital workflows for generating a personality score vector including values associated with each of the plurality of personality traits. Given that LLMs require significant computational resources to train, implement and maintain, using a computationally efficient ML model for performing inference tasks (rather than deploying computationally expensive LLMs) further helps to reduce the use of computing resources (e.g., processing power, memory, computing time, etc.) and improve computational efficiency. In this way, the inclusion of smaller classification models into digital workflows may enable the use of computational models that require fewer computations and lower storage requirements to perform accurate persona generation tasks as compared to known LLM-based approaches.

To assist in understanding the present disclosure, some concepts relevant to neural networks and machine learning (ML) are first discussed.

Machine learning (ML) is an application of artificial intelligence (AI) that provides systems the ability to automatically learn and improve from experience without being explicitly programmed. Neural networks are a foundational component of many ML systems, however other deep learning approaches may also be used. Generally, a neural network comprises a number of computation units (sometimes referred to as “neurons”). Each neuron receives an input value and applies a function to the input to generate an output value. The function typically includes a parameter (also referred to as a “weight” and/or a “bias”) whose value is learned through the process of training. A plurality of neurons may be organized into a neural network layer (or simply “layer”) and there may be multiple such layers in a neural network, for example, an input layer that accepts inputs, an output layer that generates a prediction as output, and in the case of deep neural networks (DNN), a plurality of hidden layers which are situated between the input layer and output layer. The output of one layer may be provided as input to a subsequent layer. Thus, input to a neural network may be processed through a succession of layers until an output of the neural network is generated by a final layer.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others. DNNs are often used as ML-based models for modelling complex behaviors in order to improve accuracy of outputs (e.g., more accurate predictions) such as, for example, as compared with models with fewer layers. In the present disclosure, the term machine learning model, or simply “ML model” may be understood to refer to a DNN.

In recent years, there has been interest in a type of neural network architecture, referred to as a transformer, for example, for use as language models. A transformer is a type of neural network architecture that uses self-attention mechanisms in order to generate predicted output based on input data that has some sequential meaning (i.e., the order of the input data is meaningful, which is the case for most text input). A transformer typically includes an encoder (which may comprise one or more encoder layers/blocks connected in series) and a decoder (which may comprise one or more decoder layers/blocks connected in series). Generally, the encoder and the decoder each include a plurality of neural network layers, at least one of which may be a self-attention layer. The parameters of the neural network layers may be referred to as the parameters of the transformer-based model.

Training of the ML model is a process of learning the values of the parameters (e.g., weights and/or biases) of the neurons in the layers such that the ML model is able to model the target behavior to a desired degree of accuracy. In the process of training a ML model, two approaches are commonly used: supervised learning and unsupervised learning. In unsupervised learning, the neural network is not provided with any information on desired outputs, and the neural network is trained to arrive at a set of learned weights and/or biases on its own. In supervised learning, a predicted value outputted by the ML model may be compared to a desired target value (e.g., a ground truth value). A weight vector (which is a vector containing the weights W for a given layer) of each layer of the ML model is updated based on a difference between the predicted value and the desired target value or based on some other objective function (e.g., the minimization of a loss function, or the maximization of a reward, among other possibilities). This comparison and adjustment may be carried out iteratively until a convergence condition is met, for example, a predefined maximum number of iterations has been performed, or the value outputted by the ML model is sufficiently converged with the desired target value or objective function, after which the ML model is considered to be sufficiently trained. The values of the learned parameters may then be fixed and the ML model may be deployed to generate output in real-world applications (also referred to as “inference”).

Training typically requires the use of a training dataset, which is a set of data that is relevant to the target behavior of the ML model. The training data may be a subset of a larger data set. For example, a data set may be split into three mutually exclusive subsets: a training set, a validation (or cross-validation) set, and a testing set and the three subsets of data may be used sequentially during ML model training, or other segmentations of the larger data set and/or schemes for using the segments for training one or more ML models are possible. For example, the training set may be first used to train one or more ML models, for example, where each ML model may have unique characteristics, such as a particular architecture, a particular training procedure, being describable by a set of model hyperparameters, etc. The validation (or cross-validation) set may then be used as input data into the trained ML models to measure the performance of the trained ML models and/or compare performance between them. Once such a trained ML model is obtained, output may be generated using the trained ML model based on the third subset (the testing set), for assessing the accuracy of the trained ML model.

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publicly-available text corpuses may be fine-tuned by further training the ML model using a smaller, specific dataset (e.g., the written works of one or more individuals having a particular style or tone, or transcripts of chat conversations with one or more individuals having a particular political affiliation, etc.) as training data samples, where the intended use of the ML model is generating a textual content (e.g., such as a chatbot response) in the style of the one or more individuals.

A large language model (LLM) is a type of DNN that can perform natural language processing (NLP) tasks to summarize, translate, predict and generate text and other content. Existing large language models (LLMs) may be based on a transformer architecture, where LLMs have a very large number of learned parameters (on the order of hundreds of billions), are able to accept a large number of tokens (e.g., as a language token sequence) as input and generate a large number of tokens as output. A LLM may be trained to learn billions of parameters, for example, to model how words relate to each other in a textual sequence. In examples, an LLM may be trained as a generative model (e.g., meaning that it can process input text sequences to predictively generate a meaningful output text sequence), for example, in an unsupervised manner on a large corpus derived from publicly available content, such as documents and images available to the public online. An LLM may then be fine-tuned with training datasets based on a specific application. For example, a LLM designed for chat interactions may be fine-tuned using a training dataset including chat transcripts or conversations. A LLM agent (or AI agent or multi-agents, etc.) is an advanced AI system that is based on LLMs, among other components, but which is designed for creating complex text requiring sequential reasoning. Multi-agent systems combine multiple LLM agents that are able to collaborate, thereby addressing complex problems more effectively than a single LLM.

A computing system may access a remote LLM or other generative model (e.g., a cloud-based generative model) via a software interface (e.g., an application programming interface (API)). Additionally or alternatively, such a remote generative model may be accessed via a network such as, for example, the Internet. In some implementations such as, for example, potentially in the case of a cloud-based generative model, a remote generative model may be hosted by a computer system as may include a plurality of cooperating (e.g., cooperating via a network) computer systems such as may be in, for example, a distributed arrangement. Notably, a remote generative model may employ a plurality of processors (e.g., hardware processors such as, for example, processors of cooperating computer systems). Indeed, processing of inputs by generative model may be computationally expensive/may involve a large number of operations (e.g., many instructions may be executed/large data structures may be accessed from memory) and providing output in a required timeframe (e.g., real-time or near real- time) may require the use of a plurality of processors/cooperating computing devices as discussed above.

Inputs to a LLM or other generative model may be referred to as a prompt, which is a natural language input that includes instructions to the generative model to generate a desired output. A computing system may generate a prompt that is provided as input to the generative model via its API. As described above, the prompt may optionally be processed into a token sequence prior to being provided as input to the generative model via its API. A prompt can include one or more examples of the desired output, which provides the generative model with additional information to enable the generative model to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

An “artificial intelligence (AI) agent” or an “LLM agent” is a system or program that executes tasks autonomously, for example, relying on ML and NLP models to execute the tasks. A “multi-agent” is a system of multiple autonomous AI agents that work cooperatively toward an outcome, for example, for solving and executing complex tasks in an integrated manner. In examples, in a multi-agent system (MAS), each AI agent is built and/or trained for performing specific tasks, for example, with specific skills and/or data access. In contrast to an LLM, which responds to a prompt containing instructions, an AI agent uses tools and applications at its disposal to generate workflows for decision making, interacting with external environments and performing actions. AI agents (such as those built on the “ReACT” model, which interleave reasoning and action processes) use the natural language processing capabilities associated with LLMs to interpret and respond to user inputs (such as queries or requests), perform dynamic reasoning to determine the steps that need to be taken to respond to the inputs (e.g., by interacting with external tools and applications), and then execute those steps. AI agents (particularly those operating in a multi-agent framework) may be designed for specific roles and applications.

To assist in understanding the present disclosure, the following describes some relevant terminology that may be related to examples disclosed herein.

In the present disclosure, an “audience” can mean: a group of individuals or persons comprising a segment of a wider population, where the individuals within the audience share one or more characteristics, interests, demographics etc. In some examples, an audience may include users, customers, or other contacts or stakeholders of an organization or entity, or another individual or person who shares one or more characteristics, interests, demographics etc. with user, a contact or a stakeholder of the organization or entity.

In the present disclosure, a “customer” can mean: an existing customer and/or a prospective customer of an organization; for example, an individual who has previously completed a purchase or another transaction with an organization, previously engaged with an organization or a brand, (e.g., subscribed to an email newsletter, RSS feed or SMS distribution list, subscribed to and/or followed a social media channel or feed, consumed or otherwise engaged with a digital content, reviewed a product, completed a survey etc.), or a contact or another stakeholder of the organization. In examples, the organization may have gathered or otherwise acquired data related to the customer during the previous engagement.

In the present disclosure, “demographic data” can mean: any data collected with respect to individuals within a population. For example: age, gender, nationality, location, ethnicity, socioeconomic status (e.g., based on income, education, employment, occupation etc.), marital status, etc., most of which is typically obtained by external, third-party sources beyond the organization and may or may not be traditionally accessible to an organization.

In the present disclosure, “enriched data” can mean demographic or other data that includes further information that may be inferred or derived from existing, first-party data (e.g., based on data collected directly from an organization's audience), external second-party or third-party data sources, or publicly available data, among other data sources. For example, second-party data may be data obtained or shared by a known source or trusted partner or inferred or generated by the system and/or AI agents. Third-party data may be data that is obtained from a data provider, such as data purchased from a data marketplace, among other possibilities. In some embodiments, for example, enriched data stored in a database may represent a “Master” or “Golden” dataset, for example, representing a single, well-defined, and trusted source of information, for example, acting as the “System of Record” (SOR) and/or “Source of Truth” (SOT) for organizations, among other possibilities.

In the present disclosure, “product” can mean: goods or services that are made available to users or individuals, to satisfy a need or demand of individuals, groups of individuals or organizations. For example, a product can be an object, article, or substance (e.g., that has been manufactured or refined, or virtual objects such as software, digital art, music, clothing, currency, etc.), a system, or a service, among other possibilities.

In the present disclosure, a “product descriptor” can mean: keywords, tags or terms that describe a product in a database. For example, a product descriptor may be an attribute that is stored in a data record corresponding to the product in the database. In examples, the data record may also have associated metadata that captures a past interaction with the product by a user (e.g., clicked, viewed, added to a cart, added to a wish list, reviewed, shared etc.). These descriptive keywords, tags etc. can be derived from various sources, including; text (e.g., the product description, specifications, materials, colors, other attributes etc.), images (e.g., photos, illustrations, and designs of a product), video, audio or any combination thereof (such as an article of clothing having text, a pattern or a design or image).

In the present disclosure, an “interest” can mean: A category or topic represented by content, items or objects, among other possibilities, with which an audience has historically engaged or interacted or shown some affinity towards, and which is associated with one or more personality traits or is related to the audience's personality score in some way. Examples include “art” (e.g., painting, sculpture, galleries, etc.), “music” (exploring diverse genres, playing instruments), “products” (e.g., specific brands, types of products such as shoes, cars, books etc.), “travel” (e.g., geographic locations, languages, tourism etc.), “health” (e.g., nutrition, wellness, exercise etc.), “sports” (e.g., specific sports or teams, games etc.), among other possibilities.

In the present disclosure, a “personality trait” or a “personality type” can mean a characterization of an individual's pattern of thoughts, feelings and behaviors that may be captured by one or more personality descriptors or attributes. For example, the “Big Five” personality traits (also referred to as the “the five-factor model of personality” or “OCEAN model”) include “openness”, “conscientiousness”, “extroversion”, “agreeableness” and “neuroticism”. Other models of personality include the “16 personalities” model (also known as the Myers-Briggs test) include 16 different personality types, which are based on four dichotomies of personality preferences, for example, “extraversion (E)—introversion (I)”, “sensing (S)—intuition (N)”, “thinking (T)—feeling (F)”, and “judging (J)—perceiving (P)”, among other possibilities.

In the present disclosure, a “personality score” can mean a numeric representation of an individual's personality traits or personality type, that can be used to distinguish members of an audience.

In the present disclosure, a “persona” can mean an AI-generated semi-fictionalized character or profile that can be used to represent an individual or a group of individuals (e.g., a cohort) within an audience that share similar personality traits, or other characteristics (e.g., goals, needs, motivations, behaviors, etc.), among other similarities. In examples, a persona may provide insights into the daily routines, goals, needs, motivations and behaviors, for enabling an organization to better understand a particular audience or audience segment. In exemplary embodiments, personas can be static or dynamic, or they may be grouped into one or more categories, such as “core”, “campaign”, “custom” etc. based on how or why they were generated and what they will be used for.

In the present disclosure, a “persona relevance score™ (PRS)” can mean: a dynamically calculated parameter or score corresponding to a data record in a database (e.g., corresponding to a user), or any group or cohort of data records in the database (e.g. corresponding to a persona) for predicting a likelihood of the user or group of users engaging in a desired or positive/affirming manner and/or which aligns with an organizational goal and/or performance objective. In examples, the PRS may be continually updated responsive to updates to data in a database, for example, where data may be updated responsive to each interaction, action or activity that is observed and/or tracked for a user. For example, the PRS may be used to predict a behavior associated with an audience, an audience segment or a cohort (e.g., a persona) for a given task or workflow, such as a digital communication. In exemplary embodiments, the PRS may be a ratio, for example, based on the golden ratio (e.g., a ratio known in the art that represents a ratio between two numbers that equals approximately 1.618), for example, using the equation below.

$$P R S ( H , C ) = \frac{Place Order Rate ( H )}{( Total Recipients ( H ) \times Open Rate ( H ) \times Click Rate ( H ) )}$$

In the present disclosure, a “distribution channel” or an “electronic distribution channel” can mean a medium of delivery of digital and/or other content to an audience. For example, a distribution channel may include email, text or sms messaging, application push notifications, instant messaging, a chatbot (e.g., traditional or AI-based), a telephone or audio call (including VOIP), social media, advertisements, etc., among other possibilities, such as projecting an image on to a surface from an electronic device.

In the present disclosure, “engagement data” can mean data obtained for individuals in a database that is associated with audience behavior and interactions; for example, interactions with a web page, campaign or another audience-driven workflow, that may indicate or enable assessing the campaign performance (such as audience interest in a specific product or promotion). For example, engagement data may include historic and/or current or real-time interactions of an audience with digital content, for example, representative of audience behavior and/or interests. Additionally, no interaction is also informative data that will update a corresponding user record and/or persona as potentially “not interested”. Additionally or alternatively, offline interactions, such as those at an event or at a physical retail location may generate engagement data and analytics (such as scanning a bar code or QR code located on a physical product or a digital coupon, including an event ticket) that can be fed back into the database (e.g., an organization's “consolidated” database), for example, corresponding to a user record and/or a persona.

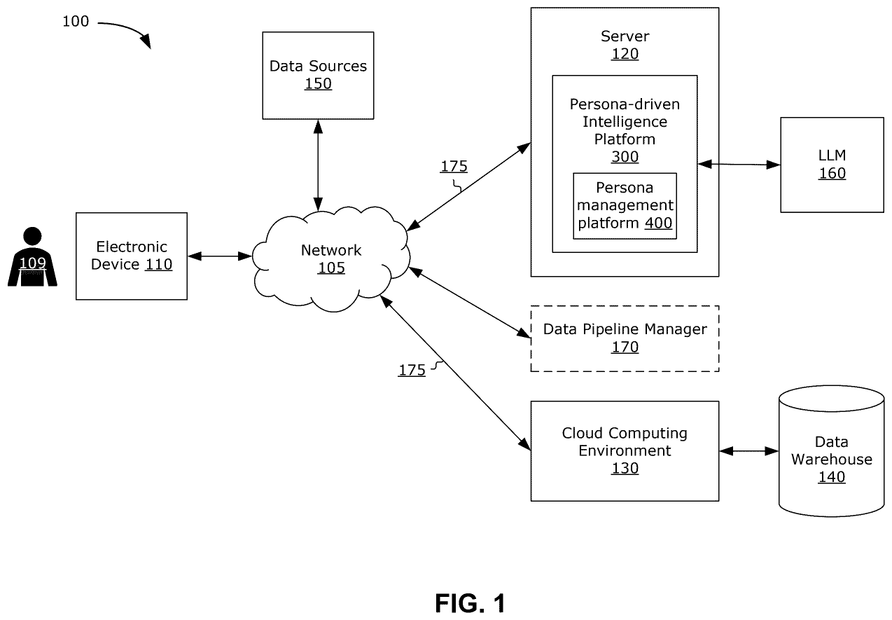

FIG. 1 is a block diagram illustrating an exemplary simplified system 100 in which exemplary embodiments of the present disclosure may be implemented. The system 100 has been simplified in this example for ease of understanding. Generally, there may be more entities and components in the system 100 than that shown in FIG. 1. The system 100 may be an integrated system for managing audience-driven workflows across a distributed network, for example, for operating a persona-driven intelligence platform 300. The system 100 may include a data communications network 105. The data communications network 105 may be any form of data communications network (e.g., an intranet, the Internet, a P2P network, a WAN and/or a LAN, or a brain-controlled interface (BCI), among other possibilities). The system 100 may further include one or more electronic devices 110 (e.g., associated with a user), a server 120, a cloud computing environment 130, a data warehouse 140, and one or more data sources 150 and may cooperate with a large language model (LLM) 160. In some embodiments, for example, the LLM 150 may be a multimodal LLM (e.g., Gemini™ LLaVA, BLIP-2, CLIP, GPT-4V, etc.).

In examples, an audience or user 109 may interact with the system 100 via an electronic device 110, for example, the electronic device 110 may connect to the network 105 in order to communicate with the server 120 and the cloud computing environment 130 to receive input (e.g., audience engagement data, campaign analytics and requests, among other inputs), and to cause the electronic device 110 to provide an output, as described herein. The electronic device 110 may include a display (not shown), for example, for providing a UI via the display that presents output on the display or via a projection onto a surface, for example, enabling the user to operate the persona-driven intelligence platform 300 of system 100. In examples, the electronic device 110 can be a desktop computer, a laptop computer, a mobile communication device (such as a smart phone or a tablet), a wearable device (such as a smart watch or VR headset), a brain-computer interface (BCI) device, or any other suitable computing device that can perform the functionality described herein.

In examples, the server 120 may include a data management system (e.g., data pipeline manager 170), for example, for acquiring and retrieving data through one or more data pipelines 175. For example, the data pipeline manager 170 may be software implemented on the server 120 or in the cloud computing environment 130, among other possibilities. In examples, the data pipeline manager 170 may include an extract, transform, and load (ETL) system or a data inference and/or enrichment system associated with the data pipeline 175, for example, for managing enterprise-level data operations across the network 105, or the data pipeline manager 170 may be configured to cooperate with an external ETL system or data enrichment system. For example, an ETL system commonly combines data from multiple sources into a central database or repository, where it can be easily accessed for analysis. In the “extract” phase, data is retrieved from one or more data sources, often in formats that are different than what is needed for storage or analysis. In the “transform” phase, the extracted data may be transformed or converted into a format that is compatible with operational requirements. Finally, in the “load” phase, the transformed data may be stored in a data warehouse or another database, making it available for analysis, visualization, reporting or other business intelligence and decision-making purposes. In exemplary embodiments, a data enrichment system may incorporate corresponding metadata (e.g., attributes) into extracted and/or transformed data, for example, based on existing first-party data, external third-party data, captured analytics (e.g., through cookies, tracking pixels and tools that support product analytics and feature management, among other possibilities) and/or inferred data from either the first-party and/or third-party data, analytics data or other derived data, such as synthetic or AI-generated enrichment data. For example, responsive to the derivation, inference or generation of new data associated with an data record in the consolidated database, the data enrichment system may stitch (e.g., add or append the generated data) onto an existing data record and/or user ID in the user database. In exemplary embodiments, the data pipeline manager 170 may manage various data workflows or pipelines, for example, associated with the acquiring, enriching, merging, stitching, etc. of data from various first party, derived and/or third-party data sources 150 and/or the retrieval of stored data from a data warehouse 140.

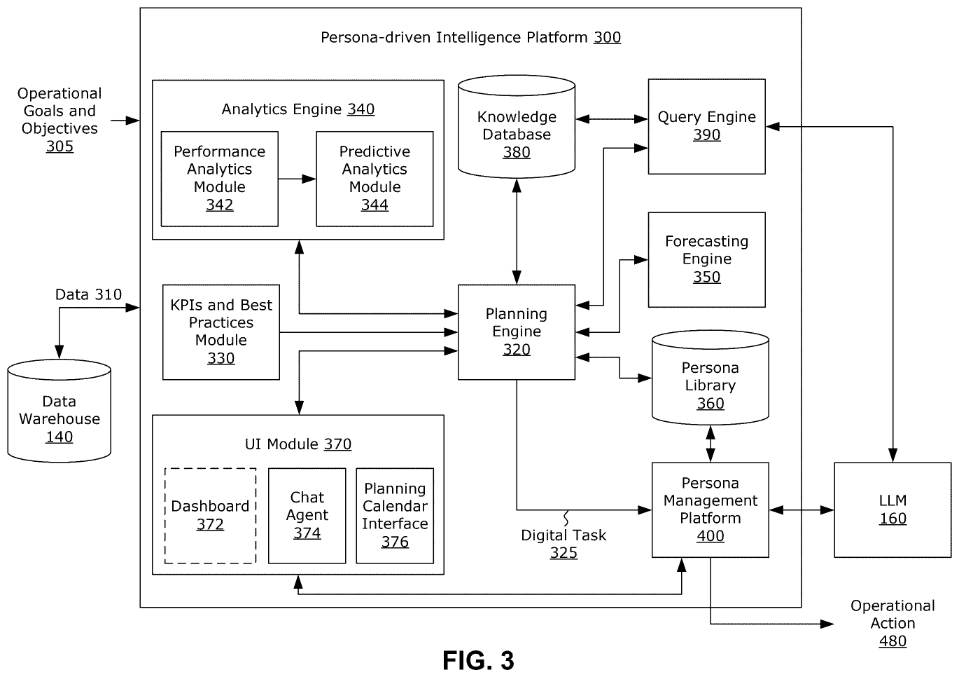

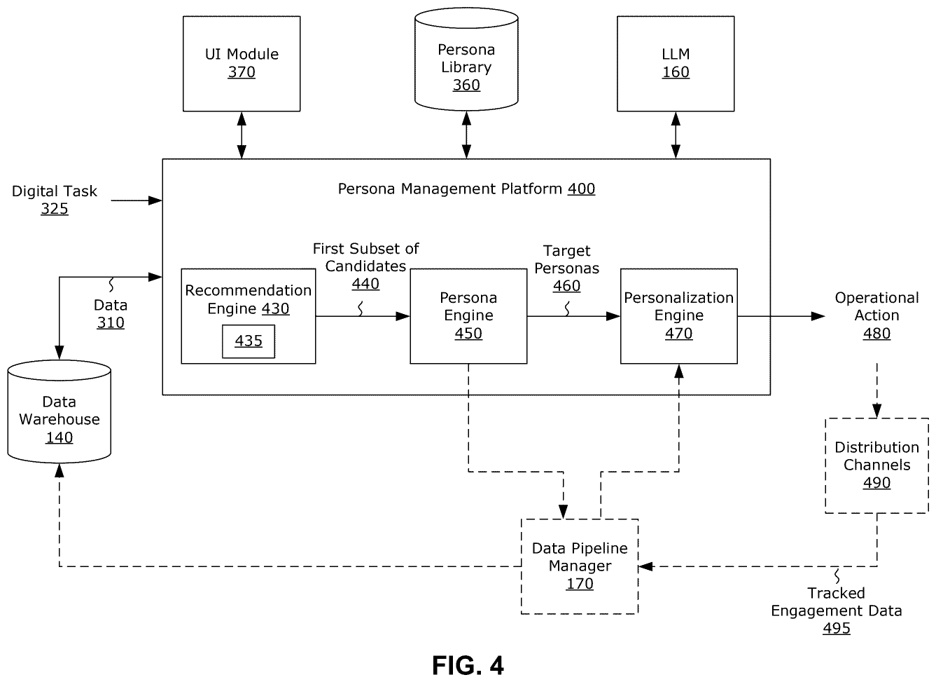

The server 120 implements a persona-driven intelligence platform 300, as further described with respect to FIG. 3 below, and a persona management platform 400, as further described with respect to FIG. 4 below. The term “server”, as used herein, is not intended to be limited to a single hardware device: the server 120 may include a server device, a distributed computing system, a virtual machine running on an infrastructure of a datacenter, or infrastructure (e.g., virtual machines) provided as a service by a cloud service provider, among other possibilities. Generally, the server 120 may be implemented using any suitable combination of hardware and software, and may be embodied as a single physical apparatus (e.g., a server device) or as a plurality of physical apparatuses (e.g., multiple machines sharing pooled resources such as in the case of a cloud service provider). The term “resources”, as used herein, can refer to hardware or software elements, for example, physical hardware infrastructure or virtual infrastructure. By way of example, resource capacity may be expressed in terms of processing power or bandwidth, memory, storage space, computing time, etc.

In examples, the cloud computing environment 130 may be configured to execute the tasks or processes of the data pipeline 175, for example, to enable the efficient processing and transformation of raw, disparate data into a structured format, for example, through the extracting and transforming of source data obtained from data sources 150 into a desired format for loading into the data warehouse 140. In examples, the cloud computing environment 130 may include a combination of hardware and software configured to receive data from, and transmit data to other components of system 100, via the network 105, and to perform functions or tasks of the data pipeline 175. In exemplary embodiments, tasks can include data extraction tasks (e.g., detecting new information in a data source, querying data, etc.), data formatting, filtering and/or cleansing tasks, data validation tasks or data warehousing tasks (e.g., loading into a target table, storing data according to database schemas etc.), among others.

In examples, the data associated with the data sources 150 may originate from third-party servers. For example, the data sources 150 can include e-commerce platforms (e.g., Shopify®), enterprise resource planning (ERP) platforms, customer relationship management (CRM) platforms, inbound and outbound marketing platforms, email marketing platforms (e.g., Klaviyo®), social media, and advertising platforms, among others), internal databases, knowledge bases, document management systems, image management systems, or other sources such as applications, sensors (for example, associated with the electronic device 110), etc. For example, an e-commerce platform may include information associated with products (e.g., goods and/or services) sold via the e-commerce platform on the organization's owned and operated assets (e.g., website, web pages), for example, through an online store, or on a third-party marketplace (e.g., Amazon®). In examples, transactional data related to products sold via the e-commerce platform, and/or related to customer purchasing or viewing behavior may be stored in third-party databases. In some embodiments, for example, third-party data sources may include data stored in a relational database management system (RDBMS), a SQL server, or one or more flat files, among other formats.

In examples, the data warehouse 140 may be a database or a distributed storage or data repository; for example, a cloud-based storage or data repository. In examples, the data warehouse 140 may store large volumes of current or historical data required to support business intelligence activities, for example, for performing queries and analysis to derive insights. In some embodiments, for example, the data warehouse 140 may include data stored in a relational database management system (RDBMS), a SQL server, or one or more flat files, among other formats, for example, providing unique data relationships through schemas and tables.

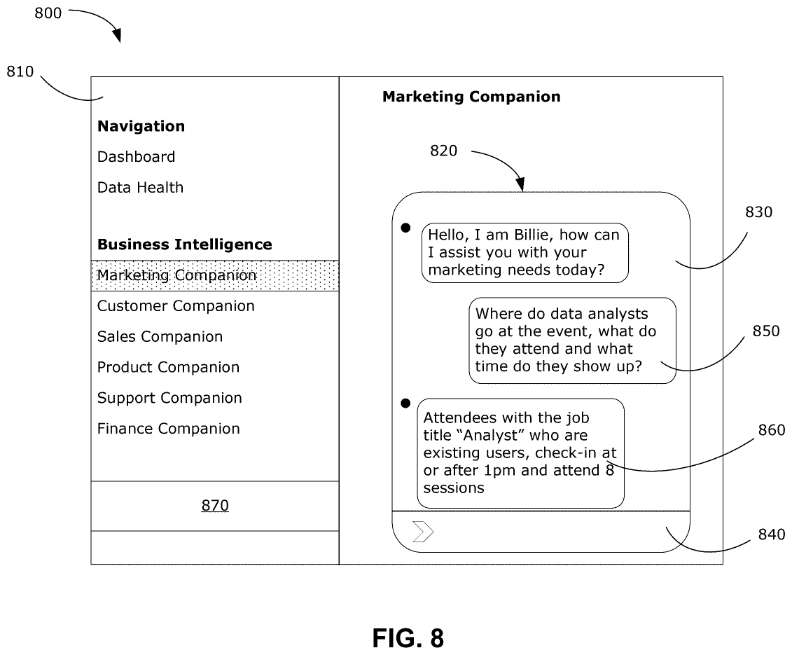

In examples, the LLM 160 may represent a language model that uses an application programming interface (API), such as such as GPT-4 and OpenAI assistant, among other possibilities. In exemplary embodiments, the LLM 160 may be accessed via a software interface (e.g., a proprietary chat interface, such as described with respect to FIG. 8), a network 105 (such as, for example, the Internet), a brain-controlled interface (BCI), or through a backend of the persona-driven intelligence platform 300 (e.g., using multi agents). In some implementations, for example, the LLM 160 may be a cloud-based language model hosted by a distributed computer system, for example, comprising a plurality of cooperating computer systems in a distributed arrangement. Notably, a distributed computing system configuration may employ a plurality of processors (e.g., hardware processors such as, for example, processors of cooperating computer systems), making the processing of inputs computationally expensive and involving many operations, such as executing many instructions and accessing various data structures from memory).

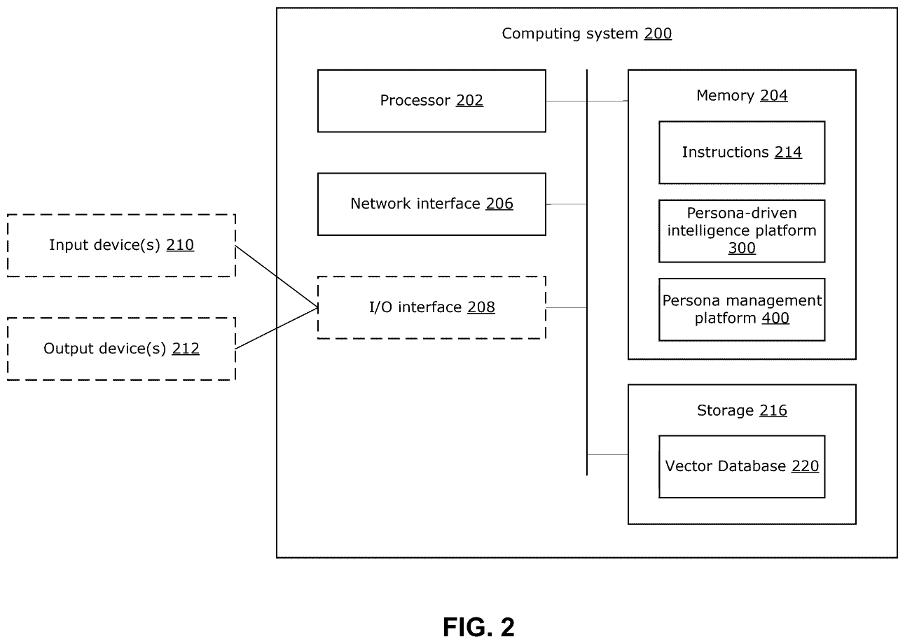

FIG. 2 illustrates an exemplary computing system 200 that may be used to implement exemplary embodiments of the present disclosure. For example, the computing system 200 may be used to implement processes of the persona-driven intelligence platform 300 or the persona management platform 400, as disclosed herein, such as performed by the server 120 in FIG. 1. In addition, the computing system 200 may be the electronic device 110, part or all of the cloud computing environment 130, the data warehouse 140, and one or more of the data sources 150. In exemplary embodiments, the persona-driven intelligence platform 300 or the persona management platform 400 may interface with a language model such as a large language model (LLM), a vision-language model (VLM), or other generative AI models and AI-powered image generation tools that create images from textual descriptions and other inputs. Additionally or alternatively, one or more instances of computing system 200 may be employed to execute the LLM and/or VLM. For example, a plurality of instances of the computing system 200 may cooperate to provide output using an LLM or VLM.

The computing system 200 includes one or more processing units and memory 204. The one or more processing units (simply referred to as processor 202) may be hardware processors. The processor 202 may be, for example, a central processing unit (CPU), a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 204 may include volatile and/or non-volatile memory (e.g., a flash memory, a random-access memory (RAM), and/or a read-only memory (ROM)). The memory 204 may store machine-executable instructions 214 for execution by the processor 202, to cause the computing system 200 to carry out the methods, functionalities, systems and modules disclosed herein. The memory 204 may include other software instructions, such as for implementing an operating system and other applications/functions.

The computing system 200 may also include at least one network interface 206 (referred to hereinafter as network interface 206 for simplicity) for wired and/or wireless communications with external systems and/or networks (e.g., an intranet, the Internet, a P2P network, a WAN, and/or a LAN). The network interface 206 may enable the computing system 200 to carry out communications (e.g., wireless communications) with systems external to the computing system 200, such as a LLM residing on a remote system. For example, the computing system 200 of FIG. 2 may access a remote system (e.g., a cloud-based system) to communicate with a remote language model or LLM (e.g., LLM 160) hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, among other possibilities. A prompt generated by the computing system 200 may be provided to the LLM 160 and the output (e.g., token sequence) generated by the LLM 160 is communicated back to the computing system 200. In other examples, the prompt may be provided directly to the LLM 160 without requiring an API call. For example, the prompt could be sent to a remote LLM via a network such as, for example, in a message (e.g., in a payload of a message).

The computing system 200 may optionally include at least one input/output (I/O) interface 208, which may interface with optional input device(s) 210 and/or optional output device(s) 212. Input device(s) 210 may include, for example, a mouse, a microphone, a camera, a touchscreen, a keyboard, BCI etc. Output device(s) 212 may include, for example, a display, a speaker, etc. In this example, optional input device(s) 210 and optional output device(s) 212 are shown external to the computing system 200. In other examples, one or more of the input device(s) 210 and/or output device(s) 212 may be an internal component of the computing system 200.

The computing system 200 may store, in the memory 204, machine-executable instructions 214, which may be executed by the processor 202 to implement the functionality disclosed herein. For example, the memory 204 may store machine-executable instructions for implementing a persona-driven intelligence platform 300, described with respect to FIG. 3 below, or the persona management platform 400, described with respect to FIG. 4 below.

In some exemplary embodiments, the computing system 200 may be a server of an online platform that provides the persona-based intelligence platform 300 as a web-based or cloud-based service that may be accessible by a user device (e.g., via communications over a wireless network). Other such variations may be possible without departing from the subject matter of the present application.

The computing system 200 may also include a storage unit 216, which may include a mass storage unit such as a solid state drive, a hard disk drive, a magnetic disk drive and/or an optical disk drive. The storage unit 216 may store data, for example, a vector database 220, among other data. In some examples, the storage unit 216 may serve as a database accessible by other components of the computing system 200. In some examples, vector database 220 may be external to the computing system 200, for example the computing system 200 may communicate with an external system to access vector database 220 (e.g., the vector database 220 may be stored in the data warehouse 140).

FIG. 3 shows a block diagram of an exemplary architecture for the persona-based intelligence platform 300, in accordance with examples of the present disclosure. The persona-based intelligence platform 300 may be a software that is implemented in the computing system 200 of FIG. 2, in which the processor 202 is configured to execute machine-executable instructions of the persona-based intelligence platform 300 stored in the memory 204. The persona-based intelligence platform 300 includes a planning engine 320, a key performance indicators (KPIs) and best practices module 330, an analytics engine 340, a forecasting engine 350, a persona management platform 400, a persona library 360, a UI module 370, an organization-specific knowledge database 380 and a query engine 390. In exemplary embodiments, the persona-based intelligence platform 300 may cooperate with a generative AI model, such as a large language model (LLM) 160. It should be understood that the blocks 320, 330, 340, 350, 360, 370, 380, 390 and 400 are exemplary and not intended to be limiting. For example, the persona-based intelligence platform 300 may include a greater or fewer number of blocks or modules than that shown. As well, operations described as being performed by a particular block or module may be additionally or alternatively performed by another subsystem.

In exemplary embodiments, the planning engine 320 may cooperate with or be connected to a business planning tool, for example, aligned with a particular industry or business sector, for capturing KPIs or best practices in alignment with an organization's goals and strategy. In examples, operational goals and/or objectives 305 for the organization or for a particular business unit of the organization, as represented by a set of one or more inputs (e.g., parameters), may be received by the persona-driven intelligence platform 300, for example, via the completion of a web-based form, among other possibilities. Responsive to the inputs, the analytics engine 340 may retrieve data 310 from the data warehouse 140 (e.g., historical operational and performance data including user data, sales data, marketing data, etc., including tracking information, such as advanced pixel tracking information, among other possibilities) and in cooperation with the performance analytics module 342 and the predictive analytics module 344, may analyze the historical operational data and generate recommendations for the organization to meet the one or more KPIs. In exemplary embodiments, the recommendations may be used to inform strategic planning and operational decisions for achieving the organizational and/or business unit goal(s), or to optimize the data. For example, the recommendations may be provided to the planning engine 320, for generating a digital task 325 to cause the persona management platform 400 to initiate a recommended operational action 480, for example, to be carried out by components of the persona-driven intelligence platform 300. In exemplary embodiments, the recommendations (or other operational insights gathered by the performance analytics module 342 or the predictive analytics module 344, such as real-time performance data or persona relevance scores 365, among other possibilities) may be provided to the UI module 370, for example, for providing a representation of the recommendation, among other data, via a dashboard 372, via a chat agent 374 (or another AI agent) or via a planning calendar interface 376 (e.g., for interfacing with a calendar tool), allowing the organization to assess the real-time performance, status of KPIs or other operational processes being tracked or forecasted by the persona-driven intelligence platform 300, for example, within the dashboard 372 or within the calendar tool. In exemplary embodiments, the recommendations and real-time status of KPIs or other tracked or forecasted information may be delivered via AI Agents (not shown) to any electronic device 110 (such as a mobile phone, headset and/or watch) via textual, image, video or audio (e.g., voice) output. For example, the dashboard 372 or planning calendar interface 376 may be communicated to an electronic device 110 to cause the electronic device 110 to display a UI generated by the UI module 370, enabling output of the dashboard 372 or the calendar tool on a display of the electronic device 110, or the chat agent 374 or another AI agent may facilitate the communication of the recommendation to an electronic device 110 to cause the electronic device 110 to output the recommendation as an audio output via a speaker of the electronic device 110.

In exemplary embodiments, the digital task 325 may be generated by the planning engine 320, for example, based on a user input received via a user interface generated by the UI module 370, such as the dashboard 372, via a user interaction with a chat agent 374, or via the planning calendar interface 376, among other possibilities. The user input may be received as a textual or voice input, for example, received as a natural language representation via a textbox object in the user interface or via voice prompt and/or voice command. For example, the user input may be an audio input, for example, received as a natural language representation via a microphone of computing system 200 and a natural language processor (NLP) may transcribe the voice command into text, or the user input may be received as a selection of an item (e.g., from a menu, a list, etc. of recommended items) in the UI or a user may perform a search operation for selecting a desired product (e.g., by name, size, color, manufacturer/brand, vendor, partner or other criteria).

In exemplary embodiments, based on the user input, the forecasting engine 350 may cooperate with the planning engine 320 to generate the digital task 325, for example, using the calendar tool. For example, when the organizational or business unit goal is related to business operations, the forecasting engine 350 may determine a potential approach for meeting the organizational or business unit goal. For example, an organizational or business unit goal may represent a satisfaction of users associated with rolling out a new version of a software product, or a reduction in the number of technical support tickets received by users of a software product, and the determined potential approach may be to coordinate communications with the user, based on the user's level of expertise or comfort with technology, among other possibilities. In this regard, the digital task 325 may correspond to an educational campaign, where the digital task 325 may include a description for the campaign and metadata associated with the software product, where the metadata associated with the software product may include the software product description, screenshots of the software platform, common challenges experienced by users and corresponding resolutions etc. In exemplary embodiments, for example, the recommendation may include a target persona (e.g., a core persona or another persona stored in the persona library 360) and the metadata may be customized based on the target persona, for example, in a manner that is predicted to achieve the organizational or business unit goal.

In another example, an organizational or business unit goal may correspond to a financial goal (e.g., revenue), and the determined potential approach for meeting the organizational or business unit goal may include increasing a revenue contribution by a particular unit or department (e.g., based on a volume of a particular product sold over a set timeframe). In this regard, the digital task 325 may correspond to a sales or marketing campaign, where the digital task 325 may include a description for the campaign and metadata associated with at least one product selected from a product database (e.g., stored in the data warehouse 140), associated with the campaign, where the metadata associated with the at least one product may include a product description, a product image, product specifications, customer reviews, among other possibilities. In exemplary embodiments, for example, the recommendation may include a target persona (e.g., a core persona or another persona stored in the persona library 360) and the metadata may be customized based on the target persona, for example, in a manner that is predicted to achieve the organizational or business unit goal. In other examples, when the inputs are related to an organizational or business unit goal related to a budget (e.g., finance), the planning engine 320 may generate a digital task 325 to determine whether an appropriate level of return on investment exists to deploy a certain budgetary amount on a specific campaign, or to recommend the hiring (or alternatively, downsizing) of additional staff or contractors, among other possibilities.

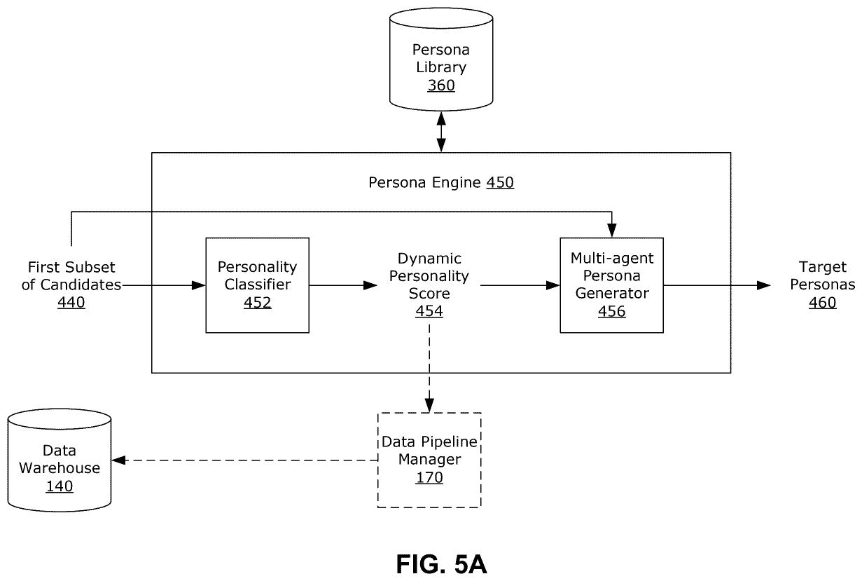

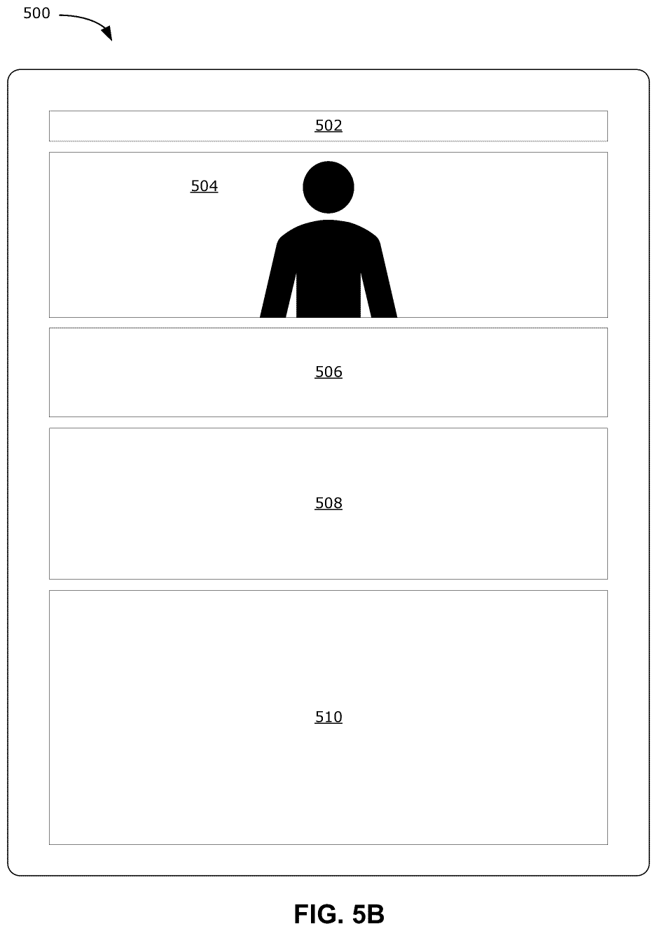

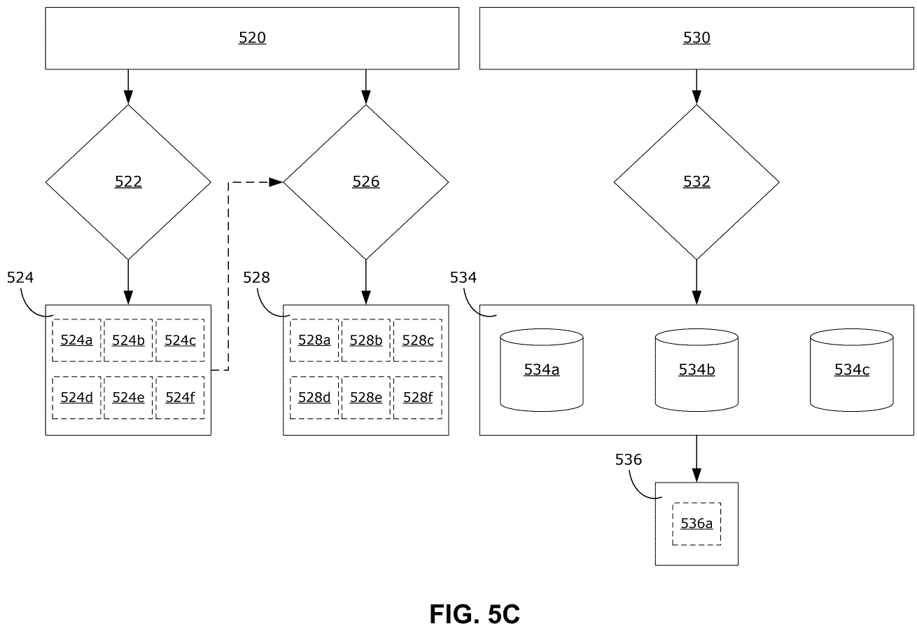

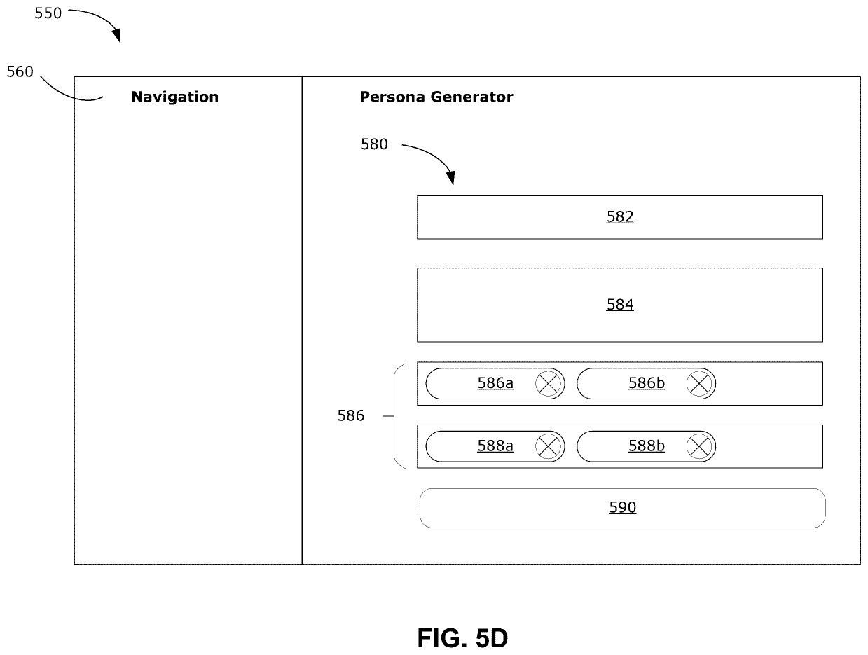

The persona library 360 may include a plurality of static and dynamic personas, for example, that have been generated for a particular organization. In examples, static personas may represent core personas associated with users or other stakeholders) of an organization that were generated at a point in time, for example, based on analysis of historical user data that has been mapped to a vector space. For example, data records corresponding to a pool of historical users may be analyzed to derive one or more personality traits or types of the pool of historical users, for example, represented numerically as a personality score. These personality scores are calculated based on various user attributes. In some embodiments, for example, characteristics of the users, (e.g., including the personality scores), may be used to cluster the pool of historical users (e.g., based on a distance between each customer in the vector space) into one or more groups or cohorts, and user data associated with each cluster may be used to generate a generalized static persona (e.g., a core persona) that is representative of the cluster. In other embodiments, other characteristics of the users (not including the personality scores) may be used to cluster the pool of historical users and generate the core personas. In exemplary embodiments, the clustering may be performed using a clustering algorithm, for example, k-means clustering, among other possibilities). For example, the number of core personas can be user-specified, a range of the number of core personas can be user specified, or the number of core personas can be dynamically determined by the clustering algorithm, etc. In exemplary embodiments, a plurality of core personas may be generated for an organization, for example, core personas may be limited to between 6-12 static personas, or other numbers may be used. In exemplary embodiments, filters may be applied to the core personas, for example, in a manner as described with respect to FIG. 4 below. In exemplary embodiments, dynamic personas may also be generated (e.g., in near real-time) for an organization, based on specific organizational and/or business unit requests or requirements, for example, based on a specific digital task 325 or forecasted information, for example, corresponding to specific campaigns or workflows, among other possibilities, as described below with respect to FIG. 4 and FIG. 5A.

FIG. 4 shows a block diagram of an example architecture for the persona management platform 400, in accordance with examples of the present disclosure. The persona management platform 400 may be a software that is implemented in the computing system 200 of FIG. 2, in which the processor 202 is configured to execute machine-executable instructions of the persona management platform 400 stored in the memory 204. The persona management platform 400 includes a recommendation engine 430, a persona engine 450, and a personalization engine 470. In exemplary embodiments, the persona management platform 400 may cooperate with a generative AI model, such as a large language model (LLM) 160 or one or more LLM agents (or multi-agents), and may further interface with the UI module 370 and the persona library 360. It should be understood that the blocks 430, 450 and 470 are exemplary and not intended to be limiting. For example, the persona management platform 400 may include a greater or fewer number of blocks or modules than that shown. As well, operations described as being performed by a particular block or module may be additionally or alternatively performed by another subsystem.

The persona management platform 400 may receive instructions and/or input corresponding to a digital task 325 and may enable the execution of an operational action 480. For example, if the digital task 325 is associated with a workflow, such as a communications or marketing campaign, the operational action 480 may correspond to the generation of one or more target digital communications associated with the campaign, where the one or more target digital communications may be delivered to a subset of users via one or more distribution channels 490, for example, for outputting to an electronic device 110.

In exemplary embodiments, responsive to receiving the instructions and/or input(s) corresponding to the digital task 325, the recommendation engine 430 may query the data warehouse 140 for retrieving data 310 associated with data records in the user database (e.g., stored in the data warehouse 140), for example, according to a persona relevance score (PRS) 435, or based on other recommendations provided by the analytics engine 340 or the forecasting engine 350. In exemplary embodiments, the PRS 435 may be calculated and stored in the data records for individual users in the user database, or for cohorts of users, for example, for identifying which personas stored in the persona library 360 are likely to be associated with a desired outcome (e.g., demonstrating the best performance) that effectively meets the organizational and/or business unit goal(s). In exemplary embodiments, the PRS 435 may be a dynamically calculated ratio that serves as a score for each user in the user database, or for each cohort of users in the user database, for example, for predicting a likelihood of positive engagement for achieving a particular business unit objective or goal. In some embodiments, for example, the retrieved data 310 may correspond to data records associated with one or more core personas for the organization, among other possibilities. The recommendation engine 430 may be a software that is implemented in the computing system 200 of FIG. 2, in which the processor 202 is configured to execute machine-executable instructions of the recommendation engine 430 stored in the memory 204.

In examples, the retrieved data records may be analyzed to generate a plurality of primary clusters of users. In exemplary embodiments, each primary cluster may comprise 200-300 individual users, among other possibilities. In exemplary embodiments, the clustering may be performed using a clustering algorithm, for example, k-means clustering, among other possibilities.

In exemplary embodiments, the recommendation engine 430 may apply one or more filters to the retrieved data associated with the plurality of primary clusters, to extract a first subset of candidates 440, for example, for providing to the persona engine 450 (described with respect to FIG. 5A below). In examples, the filters may be associated with customer demographics, personality traits, personal interests, product interests, product descriptors, transactional data, historical digital interactions (e.g., including user behavior from captured analytics, such as through cookies or tracking pixels, among other possibilities), predictive digital engagement, customer acquisition cost (CAC), customer value (LTV), return on investment (ROI) or other KPIs, among other possibilities. In this regard, the first subset of candidates 440 may comprise one or more filtered primary clusters. In other embodiments, recommendation engine 430 may apply the one or more filters to the retrieved data 310 prior to clustering, and the first subset of candidates 440 may correspond to one or more primary clusters, among other possibilities.

In exemplary embodiments, in addition to recommending the first subset of candidates 440, the recommendation engine 430, in cooperation with the UI module 370, may generate additional or affiliate recommendations (not shown), for example, recommended additional products corresponding to the at least one product selected from the product database. For example, the recommendation engine 430 may predict that the first subset of candidates 440 may also be interested in interacting with, or in other examples, interested in purchasing, the one or more additional products, for example, either as a single product and/or as a “bundle” and the recommendation engine 430 may optionally provide this information to the persona engine 450.

FIG. 5A shows a block diagram of an example architecture for the persona engine 450 in accordance with examples of the present disclosure. The persona engine 450 may be a software that is implemented in the computing system 200 of FIG. 2, in which the processor 202 is configured to execute machine-executable instructions of the persona engine 450 stored in the memory 204. The persona engine 450 includes a personality classifier 452 and a multi-agent persona generator 456. The persona engine 450 may receive as input, the first subset of candidates 440, and may output one or more target personas 460.

In exemplary embodiments, the personality classifier 452 may be a trained classification model that has been trained to predict personality traits (and/or other traits) for users in the user database, based on one or more attributes in the corresponding data records. For example, user data across each cluster of users in the first set of candidates 440 (e.g., corresponding to a primary cluster, or a filtered primary cluster, among other possibilities) may be aggregated, and one or more personality traits or types (e.g., represented numerically as a personality score) may be derived or generated for each cluster, based on the various aggregated data attributes. The corresponding personality score may then be applied to each user in the respective cluster. For example, the personality classifier 452 may output a dynamic personality score 454 for each cluster of users in the first subset of candidates 440, representative of personality traits. For example, the dynamic personality score 454 may represent an OCEAN personality classification, or another type of personality model may be used. In exemplary embodiments, the dynamic personality score 454 may be automatically updated commensurate with any new or updated user data, for example, the dynamic personality score 454 for each cluster of users in the first subset of candidates 440 may be provided to the data pipeline manager 170, for updating the user database (e.g., in the “consolidated” database in the data warehouse 140).

In examples, training the classification model may include obtaining a training dataset comprising labelled data for one or more users, including one or more personality traits, for example, associated with a personality model. In some embodiments, the personality model may include the “OCEAN model”, for example, represented as a personality score, (e.g., {‘Openness’: 67, ‘Conscientiousness’: 62, ‘Extraversion’: 40, ‘Agreeableness’: 63, ‘Neuroticism’: 30}), or another personality model may be used. The labelled dataset may be used as a training dataset for training the personality classifier 452 by supervised learning. In exemplary embodiments, the labels (e.g., personality score values) may be user generated (e.g., a user may complete an online survey that computes a personality score, among other possibilities) or the personality score may be automatically generated by an LLM (e.g., LLM 160), for example, that may or may not have been fine-tuned to generate personality scores for individual users. In examples, the LLM-generated personality score may be validated, for example, by human input.

In exemplary embodiments, generating a training dataset using an LLM may include instructing the LLM 160 to label a plurality of data records with a synthetic personality score. Input to the LLM 160 may be referred to as a prompt, which is a natural language input that includes instructions to the LLM 160 to generate a desired output. A computing system may generate a prompt (e.g., using a prompt generator) that is provided as input to the LLM via its API. For example, the prompt may instruct the LLM 160 to generate a personality score (e.g., including numerical values for each of the five personality traits associated with the “OCEAN model”, or another model, among other possibilities) for a user in the user database, based on the user data stored for that particular user in the user database. In this regard, the synthetic personality score labels may serve as ground-truth labels in the training dataset.

In exemplary embodiments, the personality classifier 452 may be trained using the assembled training dataset. In examples, the personality classifier 452 may be a machine learning model (e.g., a neural network) that has been trained (e.g., via knowledge distillation using training data that was generated by the LLM 160), to classify users according to a dynamic personality score 454. For example, the supervised machine learning model implemented by the classifier may include a linear classifier, support vector machine (SVM), decision trees, k-nearest neighbor, and random forest, among others. Various techniques may be used to train such a classifier using supervised learning. In this regard, the personality classifier 452 may represent a compressed model that has been trained to learn inherent features related to user personality traits from the LLM 160 (or a fine-tuned LLM), for example, for more efficiently generating the personality scores. Advantageously, the solution provides a technical effect of reducing the computational complexity of labelling user data (e.g., generating dynamic personality scores 454), compared to the use of a computationally expensive LLM, thereby saving computing resources (e.g. processing power, memory, computing time etc.) and reducing electricity use.

In exemplary embodiments, the multi-agent persona generator 456 may receive the user data, including the dynamic personality scores 454 for the first subset of candidates 440, for automatically generating the one or more target personas 460. For example, a target persona may represent a persona that is generated using the persona management platform 400 responsive to an operational goal and/or objective 305 or a digital task 325, among other possibilities. In examples, the multi-agent persona generator 456 may be used to generate any number of types of personas, including for example, a core persona, a campaign persona, or a custom persona, among other possibilities. In examples, the persona engine 450 may cooperate with the persona library 360, for example, for obtaining information about core personas associated with the organization, or for storing the generated target personas 460, among other possibilities. The multi-agent persona generator 456 may include one or more AI agents (e.g., ReACT agents) for generating separate aspects of each persona, for example, unique AI agents may be built and trained for generating: a brand story, demographics, engagement guidelines, tone and style, communication or other recommendations, buyer persona, persona name (and optionally, image), user features and storyline, among other possibilities. In examples, the multi-agent persona generator 456 may then compile each aspect of the persona into a complete persona (e.g., persona 500, described with respect to FIG. 5B below) of the one or more target personas 460. In exemplary embodiments, for example, each AI agent may be provided with the inputs for generating a specific portion of the persona, such as specifying the role of the AI agent (e.g., persona name creator, demographics specialist, etc.), the goal of the generated output and a backstory for providing context to the AI agent, for enabling the AI agents to generate the complete persona. For example, each AI agent may be optimized for a respective task in generating the persona. In this regard, the persona generator 456 may dynamically generate the one or more target personas 460 (e.g., as dynamic personas) that have been further customized (e.g., respect to static core personas, or other personas) according to a specific organizational or business unit goal or digital task 325. In exemplary embodiments, a unique AI agent (e.g., an AI agent specializing in generating demographics for the persona) may be provided with the following example information in order to generate the necessary demographic information for the persona:
role=‘Demographics Specialist’,
goal=‘Provide an accurate and detailed overview of the persona\\'s basic demographics, including age, gender, location, etc.’,
backstory=“““An expert in demographics, ensuring accurate representation of age, gender, location, etc. If you don't have the age on the persona_text, infer it from understanding the persona. ”””

FIG. 5B shows a schematic diagram of an example persona 500 of the one or more target personas 460, which may be implemented by an example of the persona engine 450 as disclosed herein. In the example of FIG. 5B, the persona is output to a display of an electronic device. It should be understood that this example is not intended to be limiting.

In this simple example, the persona 500 includes a “title” block 502, for example, including a representative name for the persona and a brief description. For example, a persona title may be “Trendsetter Elijah, the Fashion Rebel” or “Tired Mary, the Overloaded Working Mom”, among other possibilities. The persona may also include an “image” block 504, where an AI-generated image representative of the persona may be displayed. The persona may also include a “summary” block 506, where information representative of the individuals or users associated with the persona 500 may be displayed, for example, gender, the number of users in the user database that are associated with the persona 500, average historical transactional statistics for the users in the user database that are associated with the persona 500, ranked or top geographic location information for users in the user database that are associated with the persona 500 (e.g., location by country, state/province, city, neighborhood etc.), personality score, among other summary information.

The persona 500 may also include a “storyline” block 508, where an AI-generated narrative storyline may be provided that describes the persona 500. For example, the storyline may describe how the “a day in the life of” the persona, for example, describing activities that an actual person having similar personality traits or characteristics as the persona 500 may perform on an average day, or the storyline may provide other information for providing context around who the persona 500 is representative of within the broader pool of users in a user database.

The persona 500 may also include a “detailed description” 510 of the persona, including for example, demographics (e.g., age, gender, nationality, location, ethnicity, socioeconomic status, marital status etc.), engagement strategies (e.g., which distribution channels are most likely to engage (and convert) users associated with the persona 500), tone and style of communication (e.g., casual, formal, lighthearted, sarcastic, colourful, large print etc.), among other possibilities.

FIG. 5C shows a schematic diagram of various categories of personas, for example, automatically generated personas 520 and custom-generated personas 530, in accordance with examples of the present disclosure. In exemplary embodiments, in cooperation with the persona management platform 400, a core persona generator 522 may automatically generate a plurality of static core personas (e.g., 524a-f), for example, that are representative of the organization's most engaged users, among other possibilities. For example, a core persona 524 may enable an organization to better understand their core audience. In exemplary embodiments, in cooperation with the persona management platform 400, a dynamic persona generator 526 may generate a plurality of dynamic personas (e.g., 528a-f), for example, based on a specific organizational goal or objective. For example, the dynamic personas 528 may represent campaign personas, which may be generated responsive to a digital task 325 or forecasted information (e.g., for enabling an organization to create personalized campaigns used to communicate products, services and general business announcements, among other possibilities). In exemplary embodiments, the dynamic personas 528 may be generated based on the core personas 524, for example, where a core persona 524 may correspond to a subdivided population of individuals or users and a dynamic persona 528 may correspond to a further subdivided population of the individuals or users.

In exemplary embodiments, in cooperation with the persona management platform 400, a custom persona generator 532 may generate one or more custom personas (e.g., 536a), for example, based on a specific organizational goal or objective. For example, one or more filters (e.g., 528a-c) may be applied. In exemplary embodiments, the filters 534 may include various criteria for subdividing individuals in a population, such as personality score (e.g., dynamic personality score 454, for example, based on the OCEAN personality model, or another personality score), gender, age, product, product size, product color, product type, billing cycle, etc.

While the core persona generator 522, the dynamic persona generator 526 and the custom persona generator 532 are shown as separate components, it is understood that the core persona generator 522, the dynamic persona generator 526 and/or the custom persona generator 532 may cooperate with or represent various components of the persona management platform 400, such as the persona engine 450 as described with respect to FIG. 5A.

FIG. 5D illustrates an example of a simplified persona generator UI 580 (e.g., for generating a dynamic persona 528 or a custom persona 534), which may be implemented by an example of the UI module 370 as disclosed herein, in cooperation with the persona engine 450. In the example of FIG. 5D, the persona generator UI 580 is implemented via a web page, however it is understood that this example is not intended to be limiting. In this simple example, an organizational user (e.g., a representative of an organization that is seeking to achieve an organizational goal or objective) is viewing and navigating through a web-based application 550 associated with the persona-based intelligence platform 300 that has multiple pages or tabs, as indicated in the navigation panel 560.

The persona generator UI 580 may receive a user input for generating the digital task 325, for example, associated with a marketing campaign. In exemplary embodiments, the user input may be received as a textual input, for example, received as a natural language representation via one or more textbox objects in the persona generator UI 580, or the user input may be received as a voice input, among other possibilities. For example, the user input may include a campaign name 582, a campaign description 584, and metadata 586 associated with the campaign, such as campaign products 586a, 586b or other filters, such as targeted gender (e.g., male 588a, female 588b etc.), among other possibilities. In exemplary embodiments, the persona generator UI 580 may provide the user input to the persona generator 450, for generating the one or more target personas 460.

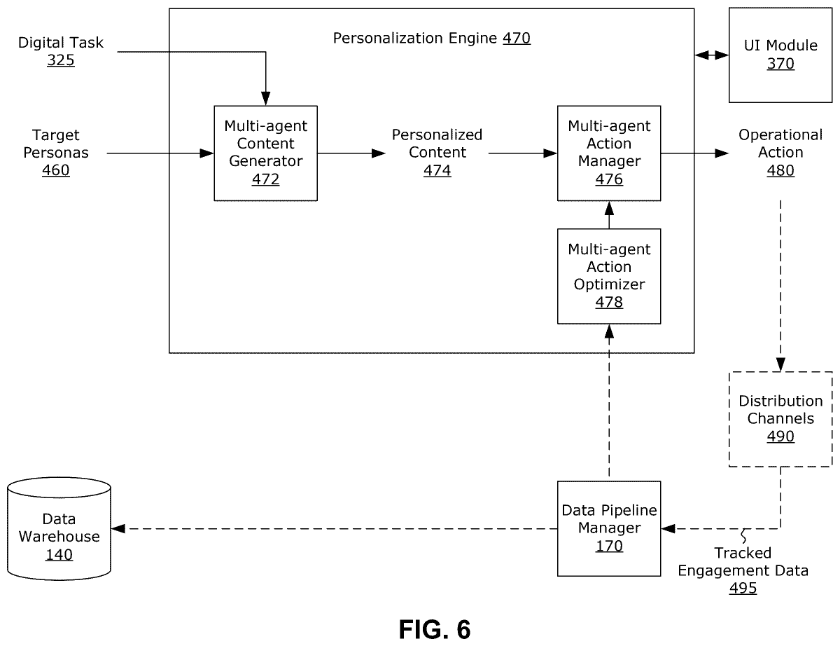

FIG. 6 shows a block diagram of an example architecture for the personalization engine 470, in accordance with examples of the present disclosure. The personalization engine 470 may be a software that is implemented in the computing system 200 of FIG. 2, in which the processor 202 is configured to execute machine-executable instructions of the personalization engine 470 stored in the memory 204. The personalization engine 470 includes a multi-agent content generator 472, a multi-agent action manager 476 and a multi-agent action optimizer 478. The personalization engine 470 may receive the one or more target personas 460, and based on the digital task 325, may enable the execution of an operational action 480. For example, when the operational request 325 is associated with a campaign, the operational action 480 may correspond to the generation of one or more target digital communications associated with the campaign, among other possibilities.

In examples, the multi-agent content generator 472 may leverage a team of agents, for example, including ReAct agents, within a multi-agent system to generate personalized communications (for example, an email, or digital ad such as social media or display) in a manner that will most likely resonate (for example, having a high propensity to resonate with the user and trigger a behavior) with the audience. For example, each AI agent of the multi-agent content generator 472 may be responsible for various tasks such as determining the copy (specific words, sentences and copy), ‘tone’ and ‘voice’ of the content, grammar, style, color palate and images, and may perform the various tasks by retrieving relevant data related (e.g., metadata associated with a certain product), interleaving reasoning and action processes and employing multiple tools and functions for generating content specific to “persona A” (e.g., Enthusiast Bob the Marathon Runner) for example, for promoting a sale associated with a certain product (e.g., lightweight running shoes). In this regard, the multi-agent content generator 472 may generate customized content for providing to an audience representative of “persona A” in a manner that resonates with the needs of the audience. For example, runners gearing up for marathon season prefer to purchase a new pair of shoes far enough in advance of a particular race to break them in, but not so far in advance that they are worn out before the race, and may respond to content with a contemporary style that includes imagery of the outdoors, as it motivates them to want to get outside to run, as well as the specific product and bundle of products (for example they may also seek new running socks) at a specific price point and promotion (for instance “persona A” may be most likely to purchase higher-end shoes with a price range of between $200 and $350, and are more likely to purchase/convert with a 5% discount code. The multi-agent content generator 472 may be a software that is implemented in the computing system 200 of FIG. 2, in which the processor 202 is configured to execute instructions multi-agent content generator 472 stored in the memory 204.

Responsive to receiving the digital task 325 (e.g., the instructions and/or input(s), etc.) and the one or more target personas 460, the multi-agent content generator 472 may automatically generate a personalized content 474, such as personalized text or imagery, among other possibilities. In exemplary embodiments, the multi-agent content generator 472 may include one or more AI agents for generating separate aspects of a personalized content 474, for example, unique AI agents may be trained for performing various tasks associated with generating the personalized content 474. For example, the personalized content may include personalized email copy and other marketing elements tailored to individual user preferences, among other possibilities. In exemplary embodiments, the generation of personalized content 474 may be an iterative multi-step process, where the output from each of the multi-agents includes suggested or recommended text (e.g. copy, call to action, language, phrasing, vocabulary etc.), tone of voice (e.g., serious, funny, formal, casual, enthusiastic, adventurous etc.), the storyline and/or narrative (e.g., based on the user's needs, challenges or what motivates them, etc.), style (e.g., formatting, such as layout, length, color, font, size, bullets, long-form text, use of emojis, headings, sections, etc.), subject line, price (e.g., cost, discounts), imagery, etc. In examples, the information contained in the target personas 460 can inform the various aspects of content generation, such that the generated personalized content 474 is highly relevant or appealing to the user, with effect that the user behaves in a desired way.

In this regard, the personalized content 474 may be an important component of any targeted operational action 480, for example, a targeted digital communication associated with a marketing campaign, may positively influence a user.

In exemplary embodiments, the personalized content 474 may be provided to the multi-agent action manager 476, for incorporating the personalized content 474 into the operational action 480, for example, if the operational action 480 is a targeted digital communication, the multi-agent action manager 476 may represent a campaign creator, and may automatically design and deploy the campaign (including the personalized content 474) across one or more distribution channels 490 (e.g., email, text or sms messaging, application push notifications, instant messaging, a chatbot, a telephone or audio call (e.g., VOIP), social media, advertisements etc.), for delivery to the subset of candidates 440, based on the target personas 460. In exemplary embodiments, the multi-agent action optimizer 478 may monitor and/or track the operation action 480, for example, for evaluating efficacy and/or success of the operational action 480. For example, when the operational action 480 is a targeted electronic communication, the action optimizer may monitor and/or track user engagement data (e.g., tracked engagement data 495) associated with the campaign, among other data, and may apply changes to future operational actions 480 based on the tracked engagement data 495. For example, modifying one or more of the personalized content 474, the one or more target personas 460, or the electronic distribution channel 490 based on the tracked engagement data 495 and/or based on updated user data. In examples, if a campaign is executed over more than one day, data insights gained from the tracked engagement data 495 (e.g., based on KPIs, engagement, behavior) can be used to further refine the campaign, including modifying content for a future communications deployment and/or for dynamically updating web-based assets, such as a website or landing page, among other possibilities. In other examples, tracked engagement data 495 may also be provided to the data pipeline manager 170, for example, for updating user records (e.g., updating data stored in the data warehouse 140, such as mapping a user into a new persona, updating behavior metrics, among other possibilities).

In exemplary embodiments, the multi-agent action optimizer 478 may determine one or more user engagement KPIs such as: customer acquisition cost (CAC), a customer lifetime value (LTV) or a return on advertising spend (ROAS) associated with the subset of candidates 440 and may modify the personalized content 474, the one or more target personas 460, or the electronic distribution channel 490 based on these or other engagement KPIs, for example, in order to optimize campaign performance and/or ROI. Advantageously, continually updating or optimizing operational actions 480 and/or user data in this way ensures that organizations are continuously adapting to changing user behaviors and preferences.

In examples, the personalization engine 470 may interface with the UI module 370 for providing users with tools to visualize data and explore insights associated with the operational insights, recommendations and/or actions that inform future strategies. Although the multi-agent action manager 476 and the multi-agent action optimizer 478 are shown as separate components, it is understood that the functions of the multi-agent action manager 476 and the multi-agent action optimizer 478 may be performed by a single component.

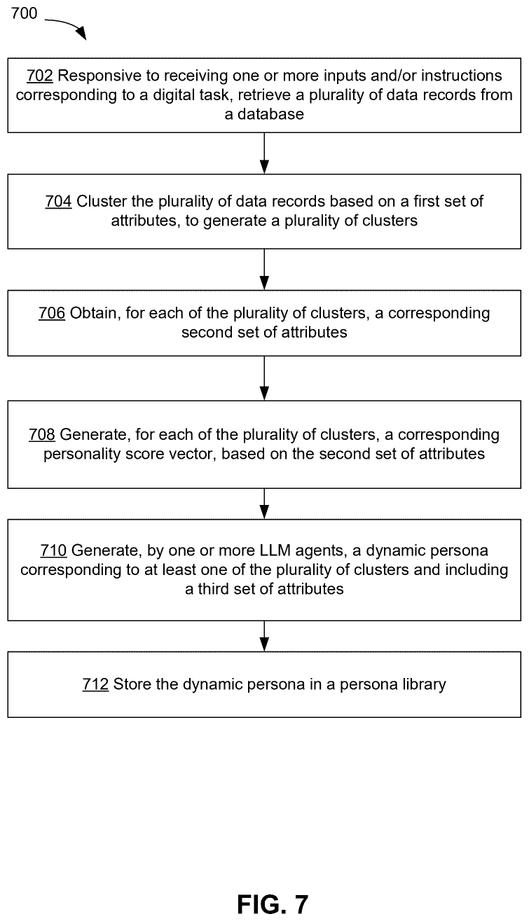

FIG. 7 is a flowchart of an example method 700 for operation of a persona-driven intelligence platform 300 in accordance with exemplary embodiments of the present disclosure. The method 700 may be performed by the computing system 200. For example, a processing unit of a computing system (e.g., the processor 202 of the computing system 200 of FIG. 2) may execute machine-executable instructions (e.g., instructions of the persona-driven intelligence platform 300) to cause the computing system to carry out the example method 700. The method 700 may, for example, be implemented by an online platform or a server, such as server 120 of FIG. 2.

At an operation 702, responsive to receiving one or more inputs and/or instructions corresponding to a digital task, a plurality of data records may be retrieved from a database, where each data record may include a first set of attributes. For example, a query may be generated and provided to a database (e.g., a user database stored the data warehouse 140) for retrieving the plurality of data records from the user database. In exemplary embodiments, for example, the plurality of data records may be retrieved based on a corresponding PRS 435 or based on other recommendations or criteria. For example, the PRS 435 may be calculated and/or stored in the data records for individual users or for cohorts of users in the user database, and may correspond to a likelihood of a positive user engagement with respect to the digital task, among other possibilities. In exemplary embodiments, for example, the plurality of retrieved data records may correspond to one or more “core” personas, for example, stored in a persona library (e.g., associated with an organization), among other possibilities.

At an operation 704, the plurality of data records may be clustered, based on the first set of attributes, to generate a plurality of clusters of data records. In exemplary embodiments, the clustering may be performed using a clustering algorithm, for example, k-means clustering, among other possibilities, where clusters of data records may share similarities in one or more corresponding attributes, among other possibilities. In exemplary embodiments, one or more filters may be applied to the plurality of data records, or to each cluster of data records, for example, to generate a plurality of filtered clusters, among other possibilities. In exemplary embodiments, each cluster may represent a plurality of users or a cohort of users, for example, each cluster may comprise 200-300 data records, among other possibilities.

At an operation 706, for each of the plurality of clusters, a corresponding second set of attributes may be obtained. For example, for each of the plurality of clusters, corresponding data records may be aggregated, for example, to generate aggregated data attributes associated with each cluster.

At an operation 708, for each of the clusters, a corresponding personality score vector (e.g., dynamic personality score 454) may be generated, based on the second set of attributes. For example, the dynamic personality score 454 may be derived or generated for each cluster, based on the aggregated data attributes. In exemplary embodiments, the dynamic personality score 454 may be generated by a trained classification model (e.g., personality classifier 452) that has been trained to predict personality traits for users, based on a set of attributes.

In exemplary embodiments, the classification model may be trained using a training dataset comprising labelled data for one or more users, including one or more personality traits, for example, associated with a personality model (e.g., OCEAN, 16 personalities, among other possibilities). Responsive to obtaining the training dataset, the classification model may be trained during a supervised learning process, for example over a plurality of training iterations, to minimize a loss between the classification model output and the training data. In exemplary embodiments, for each of the plurality of training iterations, a number of operations may be performed. For example, the model output may first be generated, based on the training dataset, where the model output may include a predicted dynamic personality score 454, among other possibilities. A loss may then be determined based on the classification model output and the training dataset. A gradient may then be computed with an objective of minimizing the loss, and the loss may be backpropagated through the classification model to update values of weights of the classification model, based on the computed gradient. In exemplary embodiments, once the plurality of training iterations is complete, a final set of model weights may be stored, for example, based on the updated weights.

At an operation 710, a dynamic persona corresponding to at least one of the plurality of clusters may be generated by one or more LLM agents. For example, the one or more LLM agents may receive the aggregated data (e.g., aggregated data attributes) corresponding to at least one of the plurality of clusters, along with the corresponding dynamic personality score 454 for the at least one of the plurality of clusters, and the one or more LLM agents may generate the dynamic persona (e.g., target persona 460) for the at least one of the plurality of clusters. In exemplary embodiments, each of the one or more LLM agents may be responsible for generating separate aspects of the dynamic persona, and the separate aspects of the dynamic persona may be compiled into a complete persona including a third set of attributes. For example, unique LLM agents may be built and trained for generating various aspects or attributes of the dynamic persona including: a brand story, demographics, psychographics, engagement guidelines, behavior guidelines, tone and style of textual content, communication recommendations, a persona name, a persona image, a persona video, persona features, a persona audio or a persona storyline, among other possibilities.

At an operation 712, the dynamic persona may be stored in a persona library 360.

FIG. 8 illustrates an example of a simplified AI chat agent UI 820, which may be implemented by an example of the chat agent 374 as disclosed herein (e.g., using the UI module 370). In the example of FIG. 8, the AI chat agent UI 820 is a chatbot UI, however it is understood that the AI chat agent UI 820 may be implemented by another type of AI agent or agents or may cooperate with another type of AI agent, other than the chat agent 374, and that this example is not intended to be limiting. In examples, the chat agent 374 may be a multi-agent chatbot that provides assistance to a user via a conversational interaction. In examples, the chat agent 374 may be a ReAct agent or another type of AI agent, that may use the natural language processing capabilities associated with LLMs to carry out user interactions.

In this simple example, an organizational user (e.g., a representative of an organization that is seeking to gain insights about the organization's customers in the organization's customer database) is viewing and navigating through a web-based application 800 associated with the persona-based intelligence platform 300 that has multiple pages or tabs, as indicated in the navigation panel 810. The AI chat agent UI 820 is presented to the user and includes a chat (or conversation) history portion 830 displaying the most recent inputs and outputs in the chat history and an input portion 840 in which the user may enter text input, such as a user query or a request or another input. In some examples, the user may provide input by other means, such as voice input and/or touch input.

An exemplary natural language chat request 850 provided by the user in the AI chat agent UI 820 is shown in FIG. 8. In examples, the chat request 850 may be directed toward a particular persona stored in the persona library 360 or the chat request 850 may generally identify a subset of customers that may or may not be associated with a persona stored in the persona library 360. For example, the user may want to know information about the behavior of a subset of customers who purchased a specific product, or who engaged with a certain marketing campaign. In response to receiving the chat request 850, the chat agent 374 may output a response that answers the user's chat request 850. For example, the chat agent 374 may cooperate with the persona management platform 400 to determine whether a persona exists in the persona library 360 corresponding to the subset of customers who purchased a specific product, such as a certain brand or category of running shoes, and in response to determining that a persona does not already exist, may cooperate with the recommendation engine 430 and/or the persona engine 450 to query the data warehouse 140 to obtain data 310 corresponding to a subset of customers known to have either purchased the certain brand or category of running shoes or who are likely to purchase the particular brand or category of shoes, for generating a target persona 460 for the subset of customers. The chat agent 374 may then generate an answer to the request, based on data associated with the target persona 460 of interest to the user. The AI chat agent UI 820 presents the response in a chat response 860 indicating that customers who like the certain brand or category of shoes with the job title “sales” and who are existing customers make purchases in-store 25% of the time and are more interested in “shoe brand/model A” compared to “shoe brand/model B and/or C”.

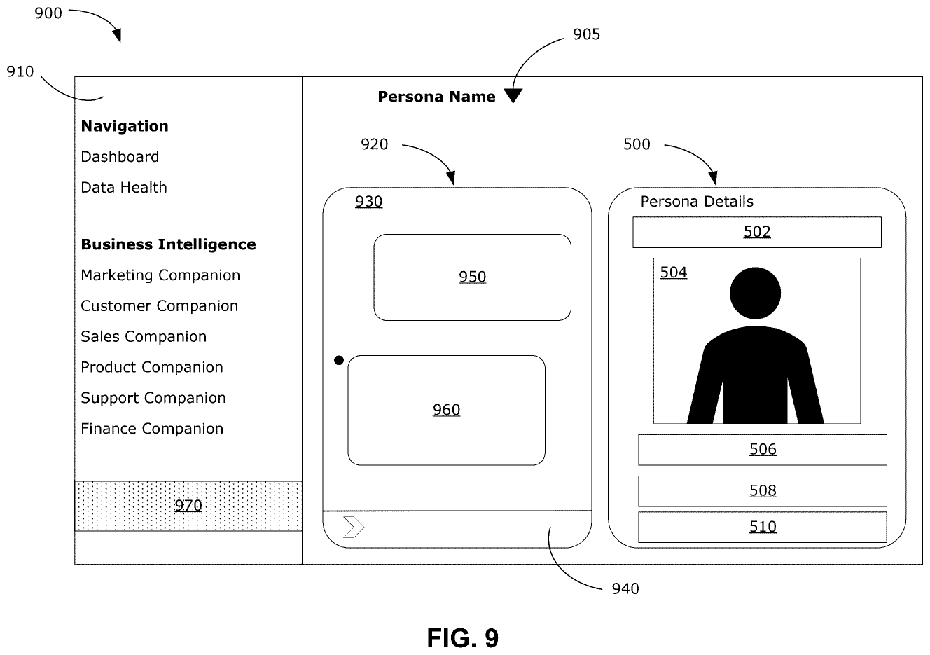

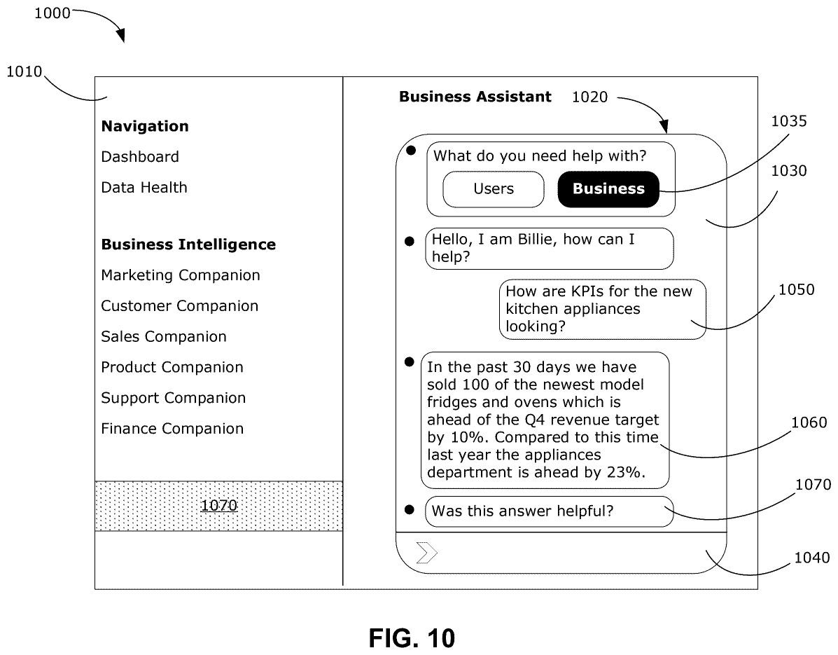

In exemplary embodiments, the navigation panel 810 may include an item 870 for chatting with a persona 970, for example, as described with respect to FIG. 9 below, or for chatting with a business assistant 1070, for example, as described with respect to FIG. 10 below.

FIG. 9 illustrates an example of a simplified AI chat agent UI 920, which may be implemented by an example of the chat agent 374 as disclosed herein (e.g., using the UI module 370). In the example of FIG. 9, the AI chat agent UI 920 is a chatbot UI, however it is understood that the AI chat agent UI 920 may be implemented by another type of AI agent or may cooperate with another type of AI agent, other than the chat agent 374, and that this example is not intended to be limiting. In examples, the chat agent 374 may be a multi-agent chatbot that provides assistance to a user via a conversational interaction. In examples, the chat agent 374 may be a ReAct agent or another type of AI agent, that may use the natural language processing capabilities associated with LLMs to carry out user interactions.

In this simple example, an organizational user (e.g., a representative of an organization that is seeking to gain insights about a specific persona 500) is viewing and navigating through a web-based application 900 associated with the persona-based intelligence platform 300 that has multiple pages or tabs, as indicated in the navigation panel 910. In exemplary embodiments, for example, the organizational user may select the persona by name using a menu 905, such as a drop-down menu, or the organizational user may search for the persona using a textbox object, among other possibilities. The AI chat agent UI 920 is presented to the user and includes a chat history portion 930 displaying the most recent inputs and outputs in the chat history and an input portion 940 in which the user may enter text input, such as a query or a request or another input. In some examples, the user may provide input by other means, such as voice input and/or touch input. In exemplary embodiments, the persona 500 may also be displayed, for example, including the title 502, the “image” block 504, the “summary” block 506, the “storyline” block 508, and the “detailed description” 510, or any combination thereof.

In FIG. 9, the user has provided a natural language chat request 950 in the AI chat agent UI 920. In examples, the chat request 950 may be directed toward the particular persona 500 stored in the persona library 360. For example, the user may want to know information about the behavior of the subset of users represented by the persona 500, for example, when the persona 500 is associated with “Tired Mary, the Overworked Mom” the chat request 950 may pose a question such as “what does your self-care routine look like?”. In response to receiving the chat request 950, the chat agent 374 may generate a response that answers the user's chat request 950, for example, based on data associated with the persona 500. The AI chat agent UI 920 outputs the response in a chat response 960 indicating that “Tired Mary” likes to sit in a coffee shop with a hot coffee and read a book that is typically a new release, or grab the coffee to-go and enjoy it on a walk with a friend.

FIG. 10 illustrates an example of a simplified AI chat agent UI 1020, which may be implemented by an example of the chat agent 374 as disclosed herein (e.g., using the UI module 370). In the example of FIG. 10, the AI chat agent UI 1020 is a chatbot UI, however it is understood that the AI chat agent UI 1020 may be implemented by another type of AI agent or agents or may cooperate with another type of AI agent, other than the chat agent 374, and that this example is not intended to be limiting. In examples, a chatbot or chat agent 374 is a type of AI that typically provides assistance to a user via a conversational interaction and makes use of LLMs to carry out user interactions.

In this simple example, an organizational user (e.g., a representative of an organization that is seeking to gain insights about the organization's activities) is viewing and navigating through a web-based application 1000 associated with the persona-based intelligence platform 300 that has multiple pages or tabs, as indicated in the navigation panel 1010. The AI chat agent UI 1020 is presented to the user and includes a chat (or conversation) history portion 1030 displaying the most recent inputs and outputs in the chat history and an input portion 1040 in which the user may enter text input, such as a user query or a request or another input. In some examples, the user may provide input by other means, such as voice input and/or touch input.

By way of example, the chat interaction with the user may begin by a user selecting an option of either “users” or “business”, for example, presented in the chat UI as a button 1035 or another selectable object, in response to a generic question such as “what do you need help with?”. In examples, the user may select “users” to engage in a chat with the AI chat agent 374 as shown in FIG. 8, or the user may select “business” to enable the AI chat agent 374 to generate responses to business intelligence queries based on data that is stored in the organization's knowledge database 380 and/or other databases in the data warehouse 140. As shown in FIG. 10, the option for “business” has been selected which instructs the AI chat agent 374 to interface with the query engine 390 for generating responses to user queries, for example, entered into the input portion 1040, among other possibilities. As previously described, the chat agent 374 may be a multi-agent chatbot that provides assistance to a user via a conversational interaction. In examples, the chat agent 374 may be a ReAct agent or another type of AI agent, that may use the natural language processing capabilities associated with LLMs to carry out user interactions.

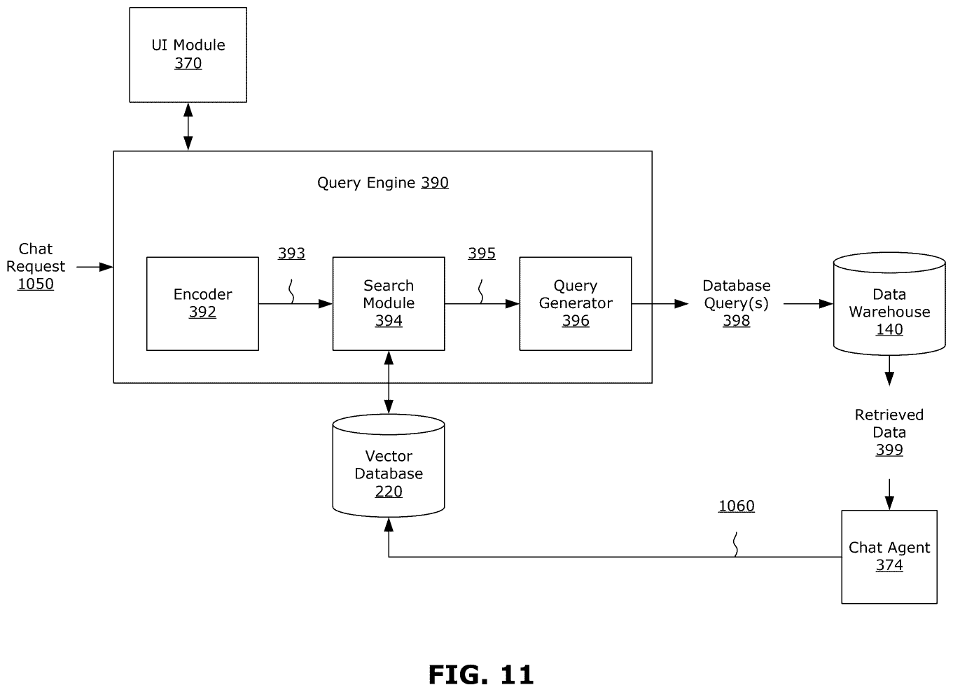

An exemplary natural language chat request 1050 provided by the user in the AI chat agent UI 1020 is shown in FIG. 10. In examples, the chat request 1050 may be directed toward organizational data stored in the organization's knowledge database 380 and/or other databases in the data warehouse 140. For example, the user may want to know information about recent sales activities for a particular department or product in the context of financial targets, among other possibilities. In response to receiving the chat request 1050, the chat agent 374 may interface with the query engine 390 to generate and output a response that answers the user's chat request 1050, as described with respect to FIG. 11 below. For example, the chat agent 374 may cooperate with the query engine 390 to query the data warehouse 140 to obtain data 310 about kitchen appliances inventory to determine that the “new kitchen appliances” in the chat request 1050 refer to the latest models of refrigerators and ovens that were received in inventory 30 days ago as well as sales data and revenue targets for the appliances department. The chat agent 374 may then generate a response for answering the request, and the AI chat agent UI 1020 may output the response in a chat response 1060 indicating the number of new kitchen appliances sold and current status of sales with respect to quarterly targets. In examples, the chat agent UI 1020 may further output a user satisfaction query 1070 to the user for evaluating the user's satisfaction with the response. In examples, the user satisfaction may be fed back into the chat agent 374 to further train and/or fine tune the AI agents, among other possibilities.

FIG. 11 shows a block diagram of an example architecture for the query engine 390, in accordance with examples of the present disclosure. The query engine 390 may be a software that is implemented in the computing system 200 of FIG. 2, in which the processor 202 is configured to execute machine-executable instructions of the query engine 390 stored in the memory 204. The query engine 390 includes an encoder 392, a search module 394, and a query generator 396. In exemplary embodiments, the query engine 390 may include one or more AI agents (e.g., ReAct agents or other types of AI agents), for example, in a multi-agent system, that may use the natural language processing capabilities associated with LLMs to carry out user interactions. For example, the query generator 396 may be an AI agent (such as a fine-tuned AI agent) or a multi-agent, among other possibilities. In examples, the query engine 390 may also interface with the UI module 370, for example, for receiving inputs or providing outputs. The query engine 390 may receive input via the chat request 1050 and may enable the generation of one or more database queries 398 for querying the data warehouse 140.

As will be discussed further below, the query engine 390 may be a retrieval augmented generation (RAG)-based engine for retrieving relevant database query text for generating the one or more database queries 398. RAG is an AI framework that may be used by search engines or LLM-based chatbots to improve the quality of generated responses. For example, rather than relying on the knowledge inherent to the LLM at the time it was trained (e.g., the knowledge contained in the dataset on which the LLM was trained), a RAG-based engine retrieves data from internal sources (e.g., a knowledge database) and/or external sources (e.g., public data accessible via the internet) to augment the inherent knowledge of the LLM, thereby improving the quality of response generation. Conventionally, AI-based chatbots or other existing search methods employing the RAG framework often have access to a database of stored documents and corresponding document embeddings, to assist in generating responses. An embedding is a dense, low-dimensional, continuous vector representation of discrete data—such as words, images, nodes, or tokens—in a way that captures semantic or structural relationships. In response to a user input (e.g., a query or a search request), the chatbot or search engine may encode the user input into an input embedding and perform a vector similarity search to identify, based on similarity of the corresponding embeddings, documents that are deemed relevant to the user input. Identified document(s) are then retrieved from the database and used as additional input to the LLM to generate a response to the user input. This approach can provide a technical advantage in that the LLM is provided with more relevant information to enable the LLM to generate appropriate output.

In exemplary embodiments, the query engine 390 may retrieve example database queries that may be relevant to the chat request 1050 (e.g., candidate database queries 395) from the vector database 220, for providing to the query generator 396, for generating the database queries 398. For example, the chat request 1050 may be received by the query engine 390, for example, via the UI module 370. In some embodiments, for example, the chat request 1050 may be phrased as a question (e.g., “how are KPIs for the new kitchen appliances looking?”). In examples, responsive to receiving the chat request 1050, the encoder 392 may generate an encoded representation 393 of the chat request 1050. In the present disclosure, an “encoded representation” can refer to learned representations of discrete variables as vectors of numeric values, where the “dimension” of the encoded representation corresponds to the length of the vector. In exemplary embodiments, the encoder 392 may represent an embedding model, and the encoded representation 393 may be an embedding, among other possibilities. In some examples, encoded representations may be referred to as vector representations, or simply vectors, and may be learned for neural network models. In examples, encoded representations may represent a mapping between discrete variables and a vector of continuous numbers that effectively capture meaning and/or relationships in the data and may be represented as points in a multidimensional space (which may be referred to as the vector space). In examples, encoded representations exhibiting similarity may be grouped (e.g., clustered close together) within the vector space.

In exemplary embodiments, a vector space defined by encoded representations of question/query pairs may be generated using the encoder 392. For example, a dataset of question/query pairs may be assembled, where each question/query pair represents a data-relevant question that can be answered by retrieving data from a database using a corresponding database query (e.g., a SQL query, among other possibilities). In examples, the encoder 392 may transform the plurality of question/query pairs into respective representations which may be stored in the vector database 220.

In exemplary embodiments, the encoder 392 may encode or apply a transformation to the chat request 1050 using a neural network model, to generate the vector representation of the chat request 1050 (e.g., encoded representation 393). In some cases, the chat request 1050 may include a question that is complex and cannot be answered by a single database query. For example, the query engine 390 may recognize when a chat request 1050 is complex or the query engine 390 may interface with one or more AI agents (or multi-agents) to evaluate the chat request 1050 and split the corresponding question into a series of questions or steps. In this regard, the encoder 392 may encode multiple requests for providing to the search module 394, among other possibilities. In other embodiments, for example, a context of a particular organization may be relevant in determining how to separate a complex chat request 1050 into several steps or queries, and the query engine 390 and/or the one or more AI agents may be configured to operate within the specific context of the organization.

In exemplary embodiments, the search module 394 may receive the encoded representation 393 and may interface with the vector database 220 to identify the one or more corresponding candidate database queries 395, based on similarity measures between the representations of the plurality of question/query pairs stored in the vector database 220 and the encoded representation 393. For example, the search module 394 may perform a vector similarity search operation (e.g., using a nearest neighbor approach, among other possibilities) within the vector space to identify the one or more candidate database queries 395. In examples, the similarity measure may be a distance measure (e.g., a Euclidean distance measured between the encoded representation 393 and representations of the plurality of question/query pairs in any direction within the vector space), or the similarity measure may be a cosine similarity (e.g., a cosine of the angle between the encoded representation 393 and representations of the plurality of question/query pairs), among other possibilities. In exemplary embodiments, the search module 394 may be customized or otherwise fine-tuned to reflect an architecture of an internal database or an organization's data platform, for example, to reflect the unique features or aspects of the data associated with a particular organization or the search module 394 may be configured to operate with a specific context of the organization.

In exemplary embodiments, the one or more candidate database queries 395 may serve as example queries for providing to the query generator 396 to generate the one or more database queries 398. For example, the query generator 396 may use the chat request 1050 and the one or more candidate database queries 395 as input to an AI agent or multi-agent associated with the query generator 396 to generate the one or more database queries 398 for querying the data warehouse 140 to obtain information needed to answer the data-related question in the chat request 1050. In exemplary embodiments, a context of a particular organization may be relevant in determining how to generate the one or more database queries 398, and the query generator 396 and/or the one or more AI agents may be configured to operate within the specific context of the organization, to reflect the unique features or aspects of the data associated with a particular organization.

Returning to FIG. 10, the chat agent 374 may query the data warehouse 140 using the one or more database queries 398 to obtain data (e.g., retrieved data 399) needed for generating a response to the chat request 1050. For example, responsive to receiving the retrieved data 399 from the data warehouse 140, the chat agent 374 may use the retrieved data 399 from the data warehouse 140 to generate a response that answers the chat request 1050. In exemplary embodiments, the AI chat agent UI 1020 outputs the response in a chat response 1060. In examples, the chat agent 374 may also provide the chat response 1060 to the vector database 220 to be accessed by the search module 394 in future queries. For example, the query engine 390 may be continuously trained and/or improved as each new question or chat request 1050 is searched, and as each corresponding answer is generated. For example, as gaps in the vector database 220 are identified, additional question/answer pairs may automatically be encoded and added to the vector database 220 to improve the performance of the query engine 390 over time.

Examples of the disclosed solution may improve the performance of business intelligence platforms by presenting an improved experience to users. Examples of the disclosed technical solution leverage the semantic understanding capabilities of an LLM to formulate more accurate and relevant database queries, or to combine multiple database queries (e.g., sequentially, or in multiple steps, among other possibilities) thereby improving the accuracy and efficiency of data retrieval and response generation and reducing the unnecessary consumption of computing resources (e.g. processing power, memory, computing time, etc.) associated with performing multiple iterations of prompting to achieve a desired result from the query generator 396 and/or chat agent 374, among other possibilities.

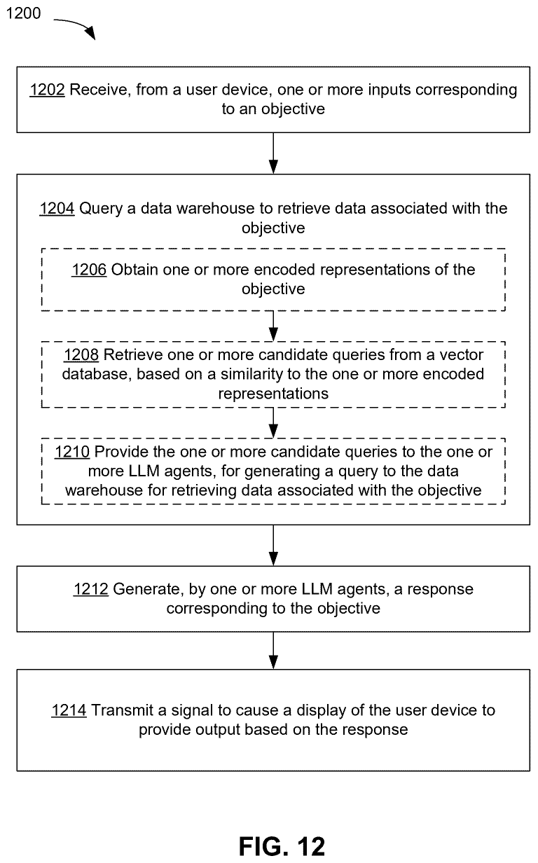

FIG. 12 is a flowchart of an example method 1200 for operation of a persona-driven intelligence platform 300 in accordance with exemplary embodiments of the present disclosure. For example, the method 1200 may enable the AI chat agent 374 to generate responses to user queries based on data that is stored in the organization's knowledge database 380 and/or other databases in the data warehouse 140, among other possibilities. The method 1200 may be performed by the computing system 200. For example, a processing unit of a computing system (e.g., the processor 202 of the computing system 200 of FIG. 2) may execute machine-executable instructions (e.g., instructions of the persona-driven intelligence platform 300) to cause the computing system to carry out the example method 1200. The method 1200 may, for example, be implemented by an online platform or a server, such as server 120 of FIG. 2.

At an operation 1202, one or more inputs corresponding to an objective may be received, for example, from a user device. In examples, the one or more inputs may represent a natural language chat request 1050 provided by a user in the AI chat agent UI 1020, for example, the chat request 1050 may be a natural language input directed toward organizational data stored in the organization's knowledge database 380 and/or other databases in the data warehouse 140.

At an operation 1204, the data warehouse 140 may be queried to retrieve data associated with the objective. In examples, at an operation 1206, one or more encoded representations 393 of the objective may be obtained. For example, the encoder 392 may encode or apply a transformation to the chat request 1050 using a neural network model, to generate the encoded representation 393. In examples, at an operation 1208, the search module 394 may receive the encoded representation 393 and may interface with the vector database 220 to identify the one or more corresponding candidate database queries 395, based on similarity measures between the encoded representation 393 representations of a plurality of question/query pairs stored in the vector database 220. In examples, at an operation 1210, the one or more candidate database queries 395 may be provided to one or more LLM agents for generating a query to the data warehouse for retrieving data associated with the objective. For example, the query generator 396 may use the chat request 1050 and the one or more candidate database queries 395 as input to an AI agent or multi-agent associated with the query generator 396 to generate the one or more database queries 398 for querying the data warehouse 140 to obtain information needed to answer the data-related question in the chat request 1050.

At an operation 1212, a response corresponding to the objective may be generated by one or more LLM agents, for example, based on the retrieved data. For example, the chat agent 374 may generate a response that answers the user's chat request 1050, using the retrieved data as an input, for example, for augmenting the chat agent 374 in generating the response.

At an operation 1214, a signal may be transmitted to cause a display of the user device to provide output based on the response. For example, the AI chat agent UI 1020 may output the response in a chat response 1060.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable an electronic device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer-implemented method for operating a persona-driven intelligence platform comprising:
responsive to receiving one or more inputs and/or instructions corresponding to a digital task, retrieving, from a database in memory of a computing system, a plurality of data records, each data record including a first set of attributes;
clustering the plurality of data records to generate a plurality of clusters of data records, based on the first set of attributes;
obtaining, for each of the plurality of clusters, a corresponding second set of attributes;
generating, for each of the plurality of clusters, a corresponding personality score vector, based on the second set of attributes;
generating, by one or more LLM agents, a dynamic persona corresponding to at least one of the plurality of clusters, the dynamic persona including a third set of attributes; and
storing the dynamic persona in a persona library.

2. The method of claim 1, further comprising:
responsive to receiving the one or more inputs, generating a targeted digital communication corresponding to the digital task, wherein generating the targeted digital communication comprises:
generating, by the one or more LLM agents a personalized content for the targeted digital communication, based on the third set of attributes; and
delivering the targeted digital communication including the personalized content to a group of users associated with the at least one of the plurality of clusters via an electronic distribution channel.

3. The method of claim 1, wherein the plurality of data records is retrieved from the database based on a persona relevance score (PRS), the PRS corresponding to a likelihood of a positive user engagement with respect to the digital task.

4. The method of claim 3, wherein the PRS is calculated based on engagement metrics corresponding to historical user interactions captured in the plurality of data records, the engagement metrics including at least:
a place order rate;
a total number of recipients;
an open rate;
a click rate; and
a non-engagement data.

5. The method of claim 1, wherein the plurality of data records that are retrieved from the database correspond to one or more core personas stored in the persona library.

6. The method of claim 1, wherein obtaining the second set of attributes comprises:
for each of the plurality of clusters:
aggregating the corresponding data records to generate the second set of attributes.

7. The method of claim 1, wherein the personality score vector for each of the plurality of clusters is generated by a fine-tuned LLM.

8. The method of claim 1, wherein the personality score vector for each of the plurality of clusters is generated by a trained classification model.

9. The method of claim 1, wherein the personality score vector is a numerical representation of one or more personality traits corresponding to an OCEAN personality model or a 16 personalities model.

10. The method of claim 1, wherein the third set of attributes includes at least one of:
a brand story;
demographics;
psychographics;
engagement guidelines;
behavior guidelines;
tone and style of textual content;
communication recommendations;
a persona name;
a persona image;
a persona video;
persona features;
a persona audio; or a persona storyline.

11. The method of claim 1, wherein the one or more LLM agents are multi-agents.

12. A system comprising:
one or more processor devices; and
one or more memories storing machine-executable instructions, which when executed by the one or more processor devices, cause the system to:
responsive to receiving one or more inputs and/or instructions corresponding to a digital task, retrieve, from a database in memory of a computing system, a plurality of data records, each data record including a first set of attributes;
cluster the plurality of data records to generate a plurality of clusters of data records, based on the first set of attributes;
obtain, for each of the plurality of clusters, a corresponding second set of attributes;
generate, for each of the plurality of clusters, a corresponding personality score vector, based on the second set of attributes;
generate, by one or more LLM agents, a dynamic persona corresponding to at least one of the plurality of clusters, the dynamic persona including a third set of attributes; and
store the dynamic persona in a persona library.

13. The system of claim 12, wherein the machine-executable instructions, when executed by the one or more processor devices, further cause the system to:
responsive to receiving the one or more inputs, generate a targeted digital communication corresponding to the digital task by:
generating, by the one or more LLM agents a personalized content for the targeted digital communication, based on the third set of attributes; and
delivering the targeted digital communication including the personalized content to a group of users associated with the at least one of the plurality of clusters via an electronic distribution channel.

14. The system of claim 12, wherein the plurality of data records is retrieved from the database based on a persona relevance score (PRS), the PRS corresponding to a likelihood of a positive user engagement with respect to the digital task.

15. The system of claim 14, wherein the PRS is calculated based on engagement metrics corresponding to historical user interactions captured in the plurality of data records, the engagement metrics including at least:
a place order rate;
a total number of recipients;
an open rate;
a click rate; and
a non-engagement data.

16. The system of claim 12, wherein the plurality of data records that are retrieved from the database correspond to one or more core personas stored in the persona library.

17. The system of claim 12, wherein in obtaining the second set of attributes, the machine-executable instructions, when executed by the one or more processor devices, cause the system to:
for each of the plurality of clusters:
aggregate the corresponding data records to generate the second set of attributes.

18. The system of claim 12, wherein the personality score vector for each of the plurality of clusters is generated by a fine-tuned LLM.

19. The system of claim 12, wherein the personality score vector for each of the plurality of clusters is generated by a trained classification model.

20. A non-transitory computer-readable medium having machine-executable instructions stored thereon which, when executed by one or more processors of a computing system, cause the computing system to:
responsive to receiving one or more inputs and/or instructions corresponding to a digital task, retrieve, from a database in memory of a computing system, a plurality of data records, each data record including a first set of attributes;
cluster the plurality of data records to generate a plurality of clusters of data records, based on the first set of attributes;
obtain, for each of the plurality of clusters, a corresponding second set of attributes;
generate, for each of the plurality of clusters, a corresponding personality score vector, based on the second set of attributes;
generate, by one or more LLM agents, a dynamic persona corresponding to at least one of the plurality of clusters, the dynamic persona including a third set of attributes; and
store the dynamic persona in a persona library.
